(19) United States
(12) Patent Application Publication
(10) Pub. No.: US 2026/0106696 A1
(43) Pub. Date: Apr. 16, 2026

(54) TECHNIQUES FOR TYPE INDICATIONS FOR UNSUCCESSFUL HYBRID AUTOMATIC REPEAT REQUEST PROCESS TERMINATION REPORTING

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 18/917,574

(22) Filed: Oct. 16, 2024

(51) Int. Cl. H04L 1/1812; H04L 1/1829

(52) U.S. Cl. CPC H04L 1/1812; H04L 1/1835; H04L 1/1854

(57) ABSTRACT

Various aspects of the present disclosure generally relate to wireless communication. In some aspects, a user equipment (UE) may receive, from a network node, a first communication associated with a hybrid automatic repeat request (HARQ) process. The UE may detect an unsuccessful HARQ termination event associated with the HARQ process, where the unsuccessful HARQ termination event may be associated with a type. The UE may transmit, to the network node, a second communication indicating the unsuccessful HARQ termination event, where the second communication indicates the type associated with the unsuccessful HARQ termination event.

Numerous other aspects are provided.

### FIELD OF THE DISCLOSURE

Aspects of the present disclosure generally relate to wireless communication and specifically relate to techniques, apparatuses, and methods associated with type indications for unsuccessful hybrid automatic repeat request (HARQ) process termination reporting.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to cause the UE to receive, from a network node, a first communication associated with a hybrid automatic repeat request (HARQ) process. The one or more processors may be configured to cause the UE to detect an unsuccessful HARQ termination event associated with the HARQ process, wherein the unsuccessful HARQ termination event is associated with a type. The one or more processors may be configured to cause the UE to transmit, to the network node, a second communication indicating the unsuccessful HARQ termination event, wherein the second communication indicates the type associated with the unsuccessful HARQ termination event.

Some aspects described herein relate to a network node for wireless communication. The network node may include one or more memories and one or more processors coupled to the one or more memories. The one or more processors may be configured to cause the network node to transmit, to a UE, a first communication associated with a HARQ process. The one or more processors may be configured to cause the network node to receive, from the UE, a second communication indicating an unsuccessful HARQ termination event, wherein the second communication indicates a type associated with the unsuccessful HARQ termination event.

Some aspects described herein relate to a network node for wireless communication. The network node may include one or more memories and one or more processors coupled to the one or more memories. The one or more processors may be configured to cause the network node to transmit, to a UE, a first communication associated with a HARQ process, wherein the first communication is associated with one or more service data units (SDUs) stored in a buffer of the network node. The one or more processors may be configured to cause the network node to remove the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.

Some aspects described herein relate to a method of wireless communication performed by a UE. The method may include receiving, from a network node, a first communication associated with a HARQ process. The method may include detecting an unsuccessful HARQ termination event associated with the HARQ process, wherein the unsuccessful HARQ termination event is associated with a type. The method may include transmitting, to the network node, a second communication indicating the unsuccessful HARQ termination event, wherein the second communication indicates the type associated with the unsuccessful HARQ termination event.

Some aspects described herein relate to a method of wireless communication performed by a network node. The method may include transmitting, to a UE, a first communication associated with a HARQ process. The method may include receiving, from the UE, a second communication indicating an unsuccessful HARQ termination event, wherein the second communication indicates a type associated with the unsuccessful HARQ termination event.

Some aspects described herein relate to a method of wireless communication performed by a network node. The method may include transmitting, to a UE, a first communication associated with a HARQ process, wherein the first communication is associated with one or more SDUs stored in a buffer of the network node. The method may include removing the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.

Some aspects described herein relate to a non-transitory computer-readable medium that stores a set of instructions for wireless communication by a UE. The set of instructions, when executed by one or more processors of the UE, may cause the UE to receive, from a network node, a first communication associated with a HARQ process. The set of instructions, when executed by one or more processors of the UE, may cause the UE to detect an unsuccessful HARQ termination event associated with the HARQ process, wherein the unsuccessful HARQ termination event is associated with a type. The set of instructions, when executed by one or more processors of the UE, may cause the UE to transmit, to the network node, a second communication indicating the unsuccessful HARQ termination event, wherein the second communication indicates the type associated with the unsuccessful HARQ termination event.

Some aspects described herein relate to a non-transitory computer-readable medium that stores a set of instructions for wireless communication by a network node. The set of instructions, when executed by one or more processors of the network node, may cause the network node to transmit, to a UE, a first communication associated with a HARQ process. The set of instructions, when executed by one or more processors of the network node, may cause the network node to receive, from the UE, a second communication indicating an unsuccessful HARQ termination event, wherein the second communication indicates a type associated with the unsuccessful HARQ termination event.

Some aspects described herein relate to a non-transitory computer-readable medium that stores a set of instructions for wireless communication by a network node. The set of instructions, when executed by one or more processors of the network node, may cause the network node to transmit, to a UE, a first communication associated with a HARQ process, wherein the first communication is associated with one or more SDUs stored in a buffer of the network node. The set of instructions, when executed by one or more processors of the network node, may cause the network node to remove the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.

Some aspects described herein relate to an apparatus for wireless communication. The apparatus may include means for receiving, from a network node, a first communication associated with a HARQ process. The apparatus may include means for detecting an unsuccessful HARQ termination event associated with the HARQ process, wherein the unsuccessful HARQ termination event is associated with a type. The apparatus may include means for transmitting, to the network node, a second communication indicating the unsuccessful HARQ termination event, wherein the second communication indicates the type associated with the unsuccessful HARQ termination event.

Some aspects described herein relate to an apparatus for wireless communication. The apparatus may include means for transmitting, to a UE, a first communication associated with a HARQ process. The apparatus may include means for receiving, from the UE, a second communication indicating an unsuccessful HARQ termination event, wherein the second communication indicates a type associated with the unsuccessful HARQ termination event.

Some aspects described herein relate to an apparatus for wireless communication. The apparatus may include means for transmitting, to a UE, a first communication associated with a HARQ process, wherein the first communication is associated with one or more SDUs stored in a buffer of the network node. The apparatus may include means for removing the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example associated with identifying unsuccessful terminations of hybrid automatic repeat request (HARQ) processes, in accordance with the present disclosure.

FIG. 4 is a diagram illustrating an example associated with unsuccessful terminations of HARQ processes, in accordance with the present disclosure.

FIG. 5 is a diagram illustrating an example associated with resolution of unsuccessful terminations of HARQ processes, in accordance with the present disclosure.

FIG. 6 is a diagram illustrating an example associated with resolution of unresolved HARQ processes, in accordance with the present disclosure.

FIG. 7 is a diagram illustrating an example of an unsuccessful HARQ termination report, in accordance with the present disclosure.

FIG. 8 is a diagram illustrating an example of an unsuccessful HARQ termination report, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, devices (e.g., a user equipment (UE) or a network node) may perform a hybrid automatic repeat request (HARQ) process to improve a reliability of communications exchanged between the devices. For example, a transmitting device may send a transport block (e.g., data) to a receiving device, and the receiving device may attempt to decode the data. In cases where the receiving device successfully decodes the data, the receiving device may transmit a HARQ acknowledgement (ACK) message to the transmitting device to indicate that the receiving device has successfully decoded the data. Alternatively, in cases where the receiving device fails to successfully decode the data, the receiving device may transmit a HARQ negative ACK (NACK) message to the transmitting device to indicate that the receiving device has not successfully decoded the data. In response to receiving a HARQ NACK message from the receiving device, the transmitting device may perform a retransmission associated with the transport block. For example, the transmitting device may retransmit a portion of the transport block (e.g., corresponding to the portion of the transport block that the receiving device was unable to successfully decode). Additionally, or alternatively, the transmitting device may retransmit the transport block using a same or different redundancy version (e.g., using the same or different set of coded bits associated with the transport block), which may allow for the receiving device to perform soft combining or incremental redundancy combining. Upon receiving the retransmission from the transmitting device, the receiving device may attempt to decode the transport block using a combination of the data received in the initial transmission of the transport block and the data received in the retransmission.

In some cases, the transmitting device may continue to send retransmissions associated with the transport block until the transmitting device receives a HARQ ACK message from the receiving device (e.g., indicating that the receiving device successfully decoded the transport block). In response to receiving the HARQ ACK message from the receiving device, the transmitting device may terminate the HARQ process. To terminate the HARQ process, the transmitting device may discard data associated with the transport block (e.g., from a buffer that is maintained prior to the termination of the HARQ process). In some other cases, the transmitting device may terminate the HARQ process without receiving a HARQ ACK message from the receiving device. For example, the transmitting device may terminate the HARQ process after a quantity of retransmissions performed by the transmitting device satisfies (e.g., is equal to or greater than) a quantity threshold associated with a quantity of retransmissions.

In a first example, the receiving device may receive first control information (e.g., downlink control information (DCI)) that schedules the transmission of a first transport block. The first control information may indicate that the transport block is associated with a first HARQ identifier and a new data indicator (NDI) (e.g., indicating whether the transport block is an initial transmission or a retransmission) having a first value. The receiving device may not successfully receive and/or decode the transport block. As a result, the receiving device may transmit a feedback communication that includes a HARQ NACK indication (e.g., indicating that the transport block was not successfully received or decoded by the receiving device). Later, the receiving device may receive second control information to schedule the transmission of a second (e.g., different) transport block. The second control information may indicate that the second transport block is associated with the same HARQ identifier as the first transport block and a different NDI value (e.g., the NDI indicated by the second control information may have a different value than the NDI indicated by the first control information to indicate that a new transport block is being communicated for the HARQ identifier). The reception of the second control information (scheduling a new transport block for the HARQ identifier) may be indicative to the receiving device of an unsuccessful termination of the HARQ process for the first transport block (e.g., and the HARQ identifier) because the receiving device may expect to receive a retransmission of the first transport block after transmitting the feedback communication that includes the HARQ NACK indication. Therefore, the reception of the second control information may be indicative of an unsuccessful HARQ termination event for the first transport block. That is, the first example may describe a first type of unsuccessful HARQ termination event.

In a second example, the receiving device may receive first control information (e.g., DCI) that schedules the transmission of a first transport block. The first control information may indicate that the first transport block is associated with a first HARQ identifier and an NDI having a first value. The receiving device may successfully receive and decode the first transport block. Therefore, the receiver may transmit a feedback communication for the first transport block that includes a HARQ ACK indication (e.g., indicating the successful decoding of the first transport block). Later, the receiver may receive second control information to schedule the transmission of a second (e.g., different) transport block. The second control information may indicate that the second transport block is associated with the same HARQ identifier as the first transport block and a different NDI value (e.g., the NDI indicated by the second control information may have a different value than the NDI indicated by the first control information). However, the NDI value of the second control information may be incremented from the NDI value of the first control information by more than a single step value (e.g., in scenarios where the quantity of bits for (e.g., allocated to, dedicated to, reserved for, included in) an NDI field of the DCI is equal to two or more bits). Therefore, the reception of the second control information may be indicative of an unsuccessful termination of the HARQ process for an intervening transport block (e.g., a transport block that was scheduled for transmission between the first transport block and the second transport block). That is, the second example may describe a second type of unsuccessful HARQ termination event.

In a third example, the transmitting device may configure the receiving device with a timer, where an expiration of the timer may indicate a potential unsuccessful termination of the HARQ process. For example, the receiving device may receive first control information (e.g., DCI) that schedules the transmission of a first transport block. The first control information may indicate that the first transport block is associated with a first HARQ identifier and an NDI having a first value. The receiving device may not successfully receive and/or decode the first transport block and may transmit a feedback communication that includes a HARQ NACK indication. Additionally, the receiving device may initiate the timer in response to transmitting the feedback information, where during the timer the receiving device may monitor for retransmission of the first transport block. However, if the timer expires prior to receiving a retransmission of the first transport block, then the receiving device may determine that a potential unsuccessful HARQ termination of the first transport block has occurred. That is, the third example may describe a third type of unsuccessful HARQ termination event.

In a fourth example, the transmitting device may configure the receiving device with a timer, where an expiration of the timer may indicate a potential unsuccessful termination of the HARQ process. For example, the receiving device may receive first control information (e.g., DCI) that schedules the transmission of a first transport block. The first control information may indicate that the first transport block is associated with a first HARQ identifier and an NDI having a first value. The receiving device may successfully receive and/or decode the first transport block. Therefore, the receiver may transmit a feedback communication for the first transport block that includes a HARQ ACK indication. Additionally, the receiving device may initiate the timer in response to transmitting the feedback information, where during the timer the receiving device may monitor for transmission of a second transport block associated with the HARQ process. However, if the timer expires prior to receiving the second transport block, then the receiving device may determine a potential unsuccessful HARQ termination of the HARQ process has occurred. That is, the fourth example may describe a fourth type of unsuccessful HARQ termination event.

As described with reference to the first and second example, the reception of a subsequent DCI may indicate to the receiving device that there has been an unsuccessful termination of a HARQ process. Additionally, as described with reference to the third and fourth example, the expiration of the timer configured at the receiving device may indicate potential unsuccessful termination of a HARQ process. In accordance with determining the type of unsuccessful termination of the HARQ process, the receiving device may transmit to the transmitting device a report to indicate the unsuccessful termination. In some cases, however, the information included in the report may be dependent on the type of unsuccessful termination of the HARQ process (e.g., first type, second type, third type, or fourth type). Therefore, in some examples, the information included in the report may be different for different types of unsuccessful HARQ termination events. Additionally, or alternatively, an interpretation of the information included in the report may be different for different types of unsuccessful HARQ termination events (e.g., information for a first type of unsuccessful HARQ termination event may be relative to (or with reference to) a first reference point (e.g., in time), whereas the information for a second type of unsuccessful HARQ termination event may be relative to (or with reference to) a second reference point). For example, a time indicated in the report may be relative to different reference times for different types of unsuccessful HARQ events. As another example, an NDI value indicated in a report may be relative to a latest detected DCI or a DCI after the latest detected DCI. As a result, the transmitting device may misinterpret the information included in the report, which may increase delay associated with resolving the unsuccessful termination of the HARQ process and/or result in the transmitting device incorrectly identifying information associated with the unsuccessful termination of the HARQ process. Additionally, if the transmitting device transmits a first transport block that includes one or more service data units (SDUs) (e.g., radio link control (RLC) SDUs, or SDU segments, or both), then the transmitting device may store the one or more SDUs in an associated transmission buffer until reception of a HARQ ACK indication from the receiving device indicating successful reception and decoding of the first transport block. However, while waiting for the receiving device to transmit the HARQ ACK indication, the transmitting device maintains the one or more SDUs in the transmission buffer, which may reduce storage capacity and storage efficiency at the transmitting device.

Various aspects relate generally to a UE indicating, as part of a report to a network node, a type of unsuccessful termination of a HARQ process. Some aspects more specifically relate to the UE detecting a type associated with an unsuccessful HARQ termination process and distinguishing between the different types in the report. In some examples, the report may distinguish between multiple (e.g., two, four, or another quantity) types of unsuccessful HARQ termination events. In such examples, a time stamp and/or an NDI value indicated in the report may be based on the type indicate. In some examples, the report may distinguish between the first type and the second type from the third type and the fourth type. In such examples, the time stamp indicated in the report may be based on the type indicated via the report. In some examples, the report may distinguish between the first type and the third type versus the second type and the fourth type. In such examples, the NDI value indicated in the report may be based on the type indicated via the report.

In some examples, a header of the report may indicate the type of unsuccessful HARQ termination event associated with the report. Additionally, or alternatively, the header may indicate that the report includes information associated with multiple unsuccessful HARQ termination events that are of a same type. In some other examples, a type field included in the report may indicate the type of unsuccessful HARQ termination event associated with the report. Additionally, or alternatively, the report may include multiple type fields associated with multiple respective unsuccessful HARQ termination events that are of a same type or different types.

Various aspects relate generally to, a network node removing (e.g., deleting or discarding) one or more SDUs associated with a transport block from the transmission buffer based on the network node not receiving a feedback communication from the UE associated with transport block after a time period. That is, the network node may assume that the UE successfully received and decoded the transport block if the time period expires prior to the network node receiving a feedback communication associated with the transport block (where such a feedback communication may indicate a HARQ NACK for the transport block or indicate an unsuccessful termination of a HARQ event for the transport block).

Particular aspects of the subject matter described in this disclosure can be implemented to realize one or more of the following potential advantages. In some examples, the described techniques can be used to decrease a latency and signaling overhead associated with communications between devices. For example, by the UE indicating the type of unsuccessful HARQ termination event in the report, the UE may reduce misinterpretation at the network node, which may result in faster resolution of the unsuccessful HARQ termination event, decreasing latency without increasing signal overhead. The UE and network node may further reduce signal overhead in cases where the UE indicates multiple unsuccessful HARQ termination events in one report. Additionally, the described techniques can be used to decrease complexity (e.g., the difficultness and/or the amount of resources use to implement, manage, and/or optimize various aspects of a wireless communications system) at the UE by decreasing buffering at the UE (or at another receiving device). For example, if a latency associated with an unsuccessful termination of a HARQ event is reduced by decreasing a delay associated with resolution of the unsuccessful termination of HARQ event, then the UE can decrease a usage of a data storage buffer. Further, the described techniques may be used to decrease storage use at the buffer of the network node. For example, by removing SDUs from the buffer after a defined period of time, the network node may reduce the use of storage resources without relying on explicit signaling from the UE, which may further reduce signaling overhead while also conserving memory resources of the network node.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

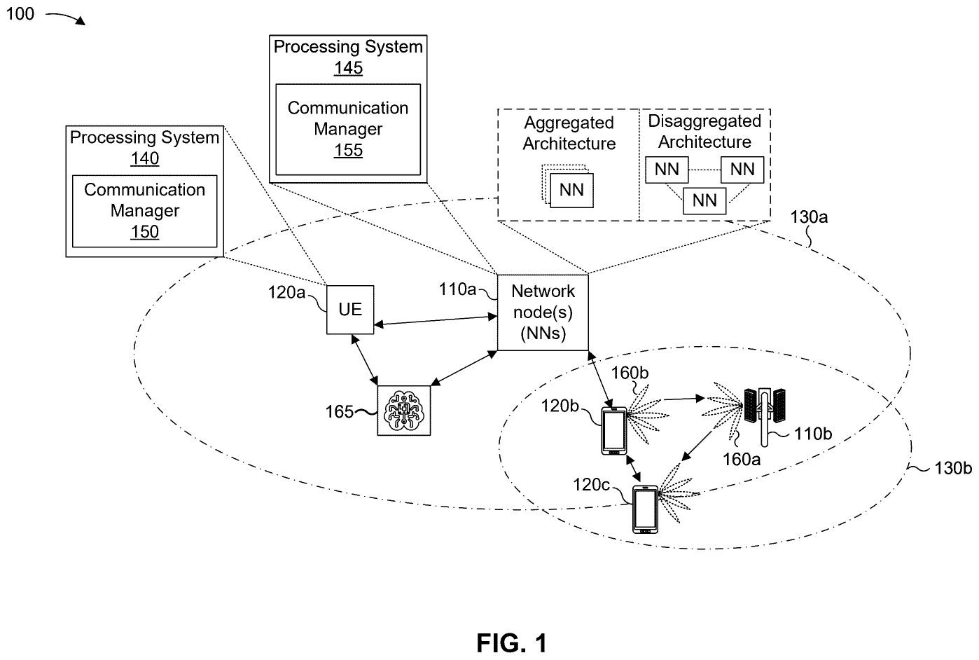

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also may output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

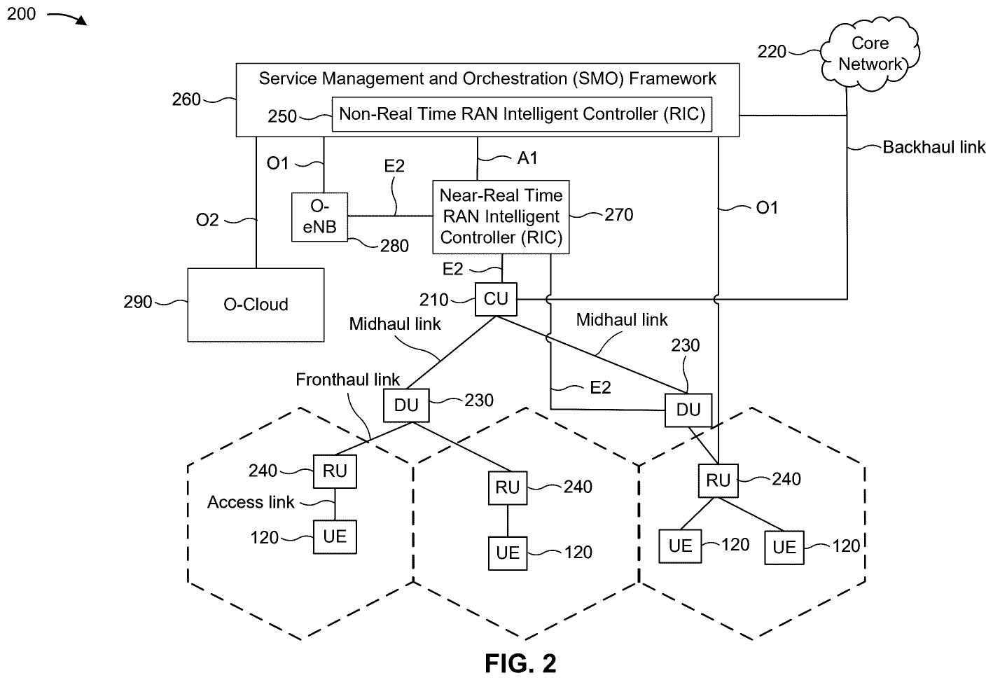

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or enhanced MTC (eMTC) UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a network node, a first communication associated with a HARQ process; detect an unsuccessful HARQ termination event associated with the HARQ process, wherein the unsuccessful HARQ termination event is associated with a type; and transmit, to the network node, a second communication indicating the unsuccessful HARQ termination event, wherein the second communication indicates the type associated with the unsuccessful HARQ termination event. Additionally, or alternatively, the communication manager 150 may perform one or more other operations described herein.

In some aspects, the network node 110 may include a communication manager 155. As described in more detail elsewhere herein, the communication manager 155 may transmit, to a UE, a first communication associated with a HARQ process; and receive, from the UE, a second communication indicating an unsuccessful HARQ termination event, wherein the second communication indicates a type associated with the unsuccessful HARQ termination event. Additionally, or alternatively, the communication manager 155 may perform one or more other operations described herein.

In some aspects, the network node 110 may include a communication manager 155. As described in more detail elsewhere herein, the communication manager 155 may transmit, to a UE, a first communication associated with a HARQ process, wherein the first communication is associated with one or more SDUs stored in a buffer of the network node; and remove the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

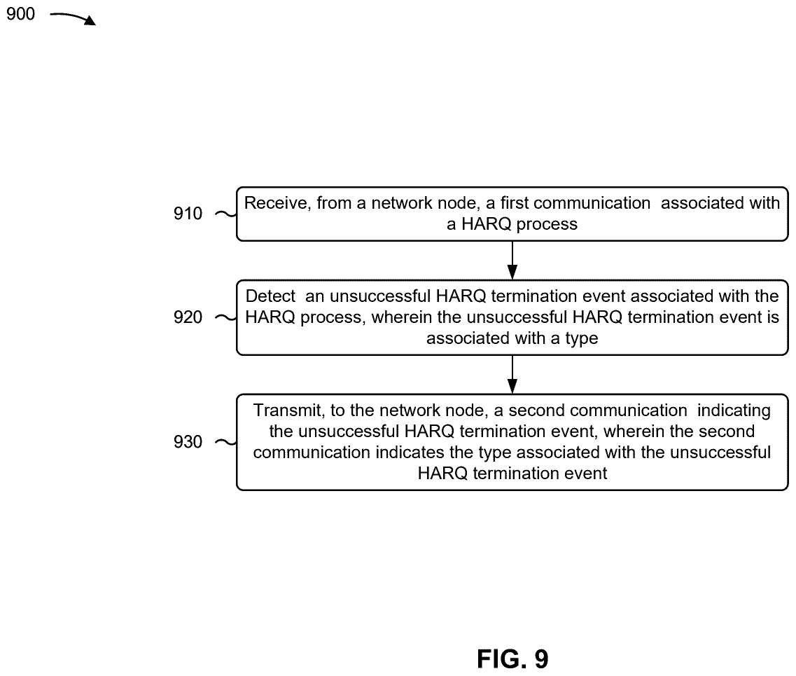

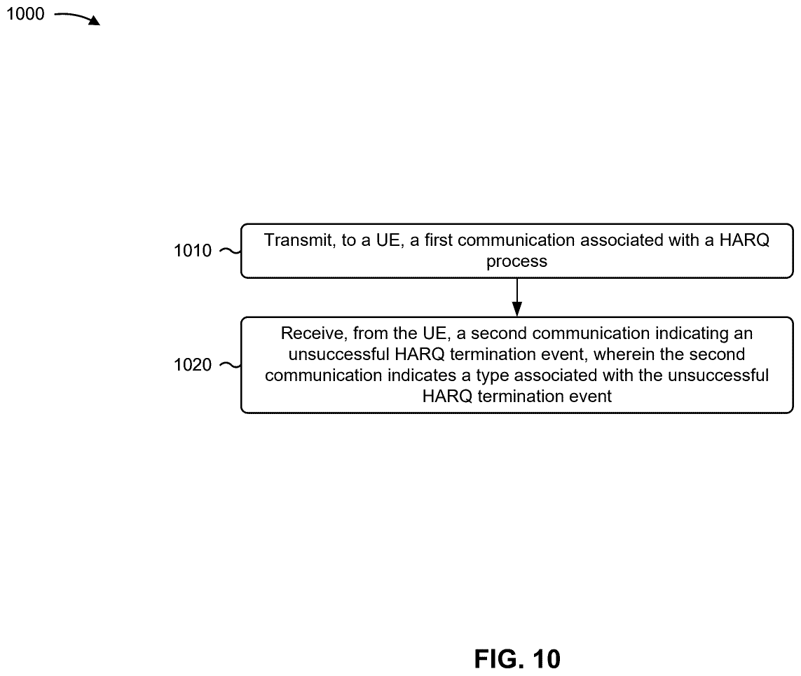

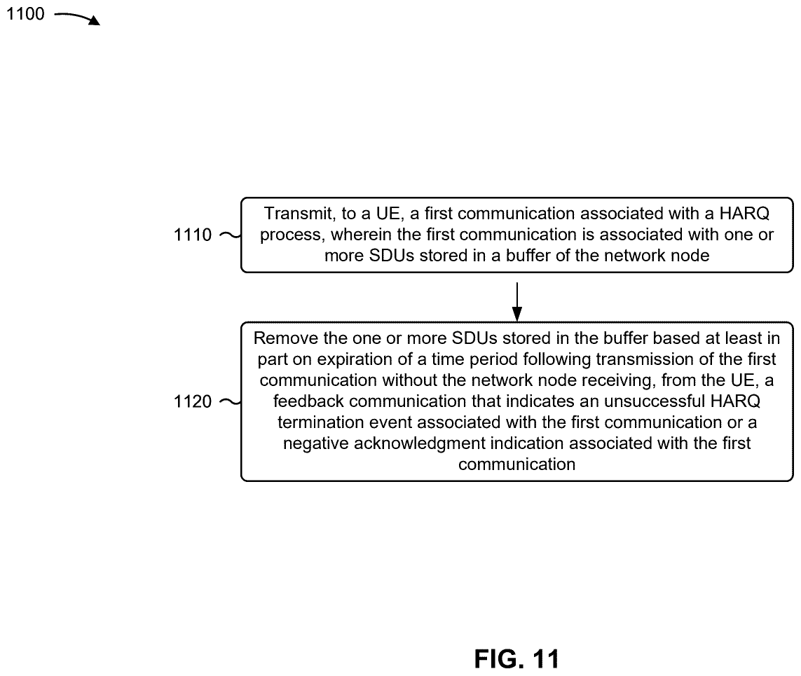

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with communication of an unsuccessful HARQ termination report that indicates a type of unsuccessful HARQ termination event, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, process 1100 of FIG. 11, or other processes as described herein. In some examples, executing instructions may include running the instructions, converting the instructions, compiling the instructions, and/or interpreting the instructions, among other examples.

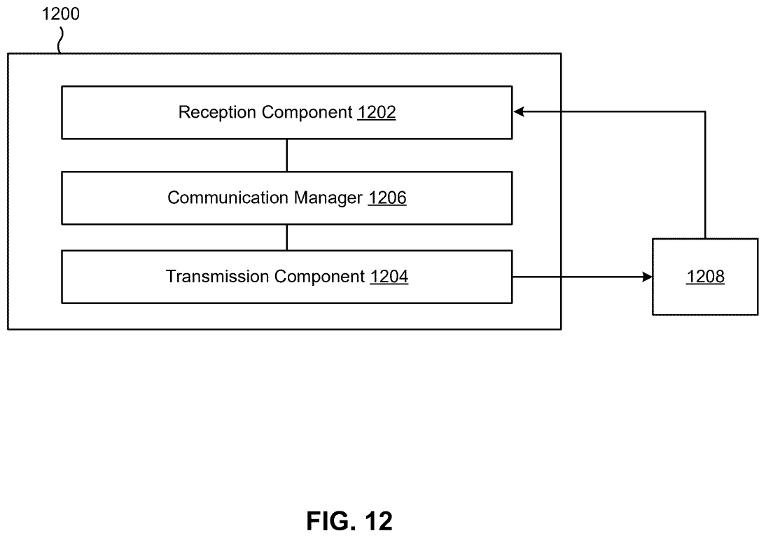

In some aspects, UE 120 includes means for receiving, from a network node, a first communication associated with a HARQ process; means for detecting an unsuccessful HARQ termination event associated with the HARQ process, wherein the unsuccessful HARQ termination event is associated with a type; and/or means for transmitting, to the network node, a second communication indicating the unsuccessful HARQ termination event, wherein the second communication indicates the type associated with the unsuccessful HARQ termination event. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

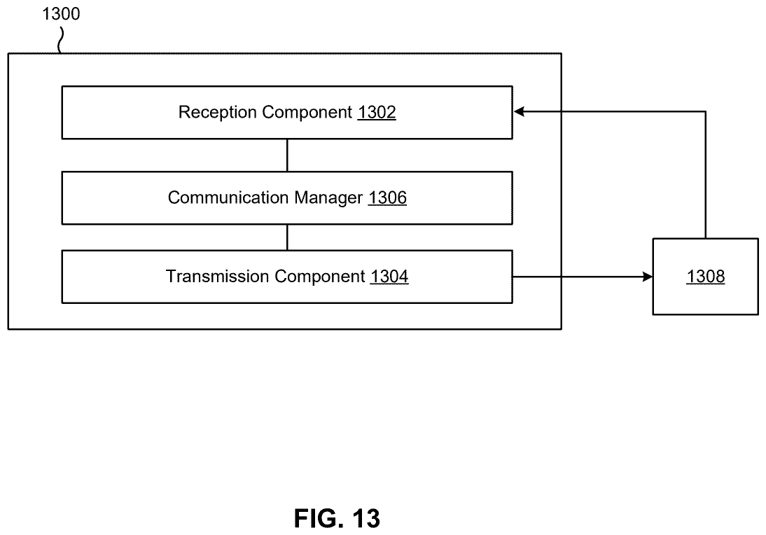

In some aspects, the network node 110 includes means for transmitting, to a UE, a first communication associated with a HARQ process; and/or means for receiving, from the UE, a second communication indicating an unsuccessful HARQ termination event, wherein the second communication indicates a type associated with the unsuccessful HARQ termination event. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

In some aspects, the network node 110 includes means for transmitting, to a UE, a first communication associated with a HARQ process, wherein the first communication is associated with one or more SDUs stored in a buffer of the network node; and/or means for removing the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication. The means for the network node 110 to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

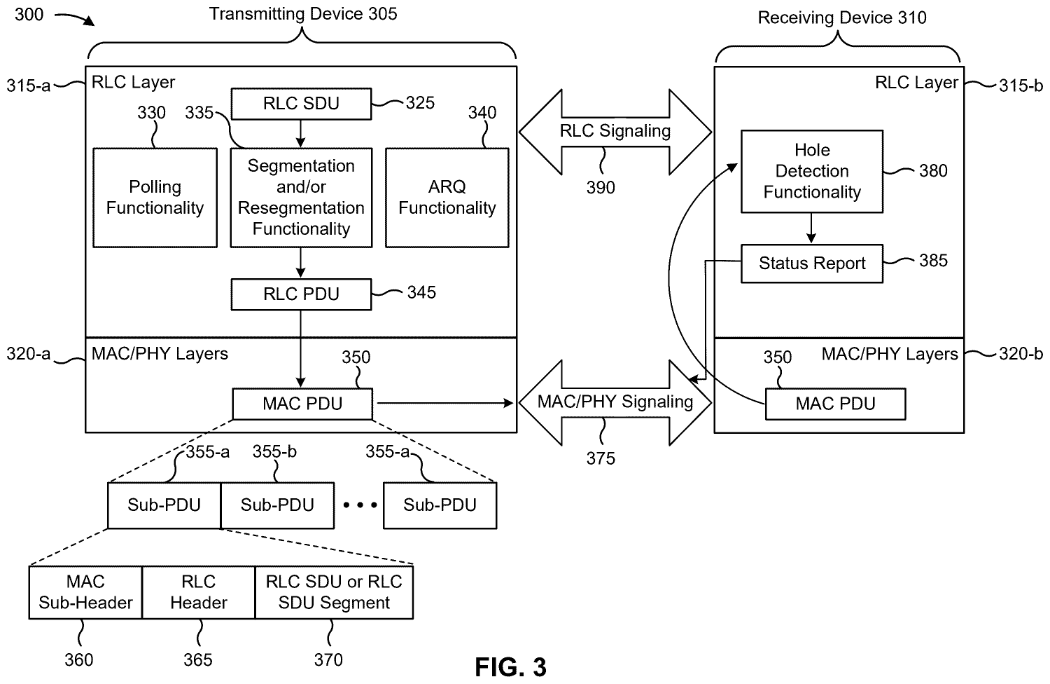

FIG. 3 is a diagram illustrating an example 300 associated with identifying unsuccessful terminations of HARQ processes, in accordance with the present disclosure. As shown in FIG. 3, a transmitting device 305 and a receiving device 310 may communicate with one another. For example, the transmitting device 305 may transmit, to the receiving device 310, the MAC packet data unit (PDU) 350.

In some cases, the transmitting device 305 may correspond to a network node 110, the receiving device 310 may correspond to a UE 120, and the transmitting device 305 may transmit communications to the receiving device 310 via a downlink. In some other cases, the transmitting device 305 may correspond to a UE 120, the receiving device 310 may correspond to a network node 110, and the transmitting device 305 may transmit communications to the receiving device 310 via an uplink.

Both the transmitting device 305 and the receiving device 310 may include an RLC layer 315 and MAC/PHY layers 320 (for example, including a MAC layer, a PHY layer, or both a MAC layer and a PHY layer). Although not illustrated, the transmitting device 305 and the receiving device 310 may also include additional layers, such as PDCP layers, RRC layers, and/or SDAP layers. In the example 300, the RLC layer 315-a of the transmitting device 305 and the RLC layer 315-b of the receiving device 310 may exchange RLC signaling 390. Additionally, the MAC/PHY layers 320-a of the transmitting device 305 and the MAC/PHY layers 320-b of the receiving device 310 may exchange MAC/PHY signaling 375.

In the example 300, the RLC layer 315-a of the transmitting device 305 may receive the RLC service data unit (SDU) 325 from a PDCP layer of the transmitting device 305. The RLC layers 315 (for example, RLC layer 315-a and RLC layer 315-b) may have multiple different modes. In particular, the transmitting device 305 and the receiving device 310 may operate the RLC layers 315 in accordance with a transparent mode, an unacknowledged mode, or an acknowledged mode. In an example where the RLC layer 315-a is operating in accordance with the transparent mode, the receiving device 310 may pass the RLC SDU 325 through the RLC layer 315-a (for example, from the PDCP layer to the MAC layer of the transmitting device 305) as an RLC PDU 345 without additional processing by the RLC layer 315-a. In another example where the RLC layer 315-a is operating in accordance with the unacknowledged mode, the transmitting device 305 may perform segmentation functionality (for example, of the segmentation and/or resegmentation functionality 335 illustrated in example 300), but may not perform the ARQ functionality 340. In another example where the RLC layer415-a is operating in accordance with the acknowledged mode, the transmitting device 305 may perform the segmentation and/or resegmentation functionality 335 and the automative repeat request (ARQ) functionality 340.

When operating the RLC layer 315-a in accordance with the acknowledgement mode, the transmitting device 305 may perform the segmentation and/or resegmentation functionality 335 to fit the RLC SDU 325 into available resources (for example, for transmission). For example, the transmitting device 305 may segment the RLC SDU 325 to generate multiple RLC SDU segments. The transmitting device 305 may perform re-segmentation functionalities (for example, of the segmentation and/or resegmentation functionality 335) to support the ARQ functionality 340, where an available payload size may change.

The RLC layer 315-a of the transmitting device 305 may generate the RLC PDU 345, which may include the RLC SDU 325. In some cases, the RLC PDU 345 may include one or multiple RLC SDUs 325 or one or multiple RLC SDU segments (for example, generated by the segmentation functionality of the segmentation and/or resegmentation functionality 335) associated with the RLC SDU 325. Each RLC SDU segment in the RLC PDU 345 may include a header that includes a sequence number associated with the RLC SDU segment. Then, the RLC layer 315-a may provide the RLC PDU 345 to the MAC/PHY layers 320-a of the transmitting device, and the MAC/PHY layers 320-a may receive the MAC PDU 350.

The MAC PDU 350 may correspond to a transport block (for example, transmitted from the transmitting device 305 to the receiving device via the MAC/PHY signaling 375). The MAC PDU 350 may include one or multiple sub-PDUs 355 (for example, MAC SDUs). Each sub-PDU 355 may include a MAC sub-header 360, an RLC header 365, and an RLC SDU or RLC SDU segment 370. In some examples, the RLC PDU 345 may correspond to the RLC header 365 and the RLC SDU or RLC SDU segment 370 in each sub-PDU 355. The RLC header 365 may include information related to the RLC SDU or RLC SDU segment 370. For example, the RLC header 365 may include a sequence number associated with the RLC SDU or RLC SDU segment 370, segmentation information associated with an RLC SDU segment of the RLC SDU or RLC SDU segments 370, and/or a segment offset associated with an RLC SDU segment of the RLC SDU or RLC SDU segments 370.

The MAC/PHY layers 320-a of the transmitting device 305 may transmit, via the MAC/PHY signaling 375, the MAC PDU 350 to the receiving device 310. The MAC/PHY layers 320-b of the receiving device 310 may provide the MAC PDU 350 to the RLC layer 315-b of the receiving device 310. The receiving device 310 may perform a HARQ process associated with the MAC PDU 350. For example, in cases where the receiving device 310 successfully decodes the MAC PDU 350, the receiving device 310 may transmit a HARQ ACK message to the transmitting device 305 via the MAC/PHY signaling 375. Alternatively, in cases where the receiving device 310 fails to successful decode the MAC PDU 350, the receiving device 310 may transmit a HARQ NACK message to the transmitting device 305 via the MAC/PHY signaling 375. In response to receiving a HARQ NACK message from the receiving device 310, the transmitting device 305 may perform a retransmission associated with the MAC PDU 350. For example, the transmitting device 305 may retransmit a portion of the MAC PDU 350 (for example, that is selected based on the portion of the MAC PDU 350 that the receiving device 310 was unable to successfully decode). Upon receiving the retransmission from the transmitting device 305, the receiving device 310 may attempt to decode the MAC PDU 350 using a combination of the data received in the initial transmission of the transport block and the data received in the retransmission.

In some cases, the transmitting device 305 may continue to transmit retransmissions associated with the MAC PDU 350 until the transmitting device 305 receives a HARQ ACK message from the receiving device 310 (for example, indicating that the receiving device successfully decodes the MAC PDU 350). In response to receiving the HARQ ACK message from the receiving device 310, the transmitting device 305 may terminate the HARQ process. In some other cases, the transmitting device 305 may terminate the HARQ process without receiving a HARQ ACK message from the receiving device 310. For example, the transmitting device 305 may terminate the HARQ process after a quantity of retransmissions performed by the transmitting device 305 satisfies (for example, is equal to or greater than) a quantity threshold associated with a quantity of retransmissions.

In cases where the RLC layer 315-b of the receiving device is operating in accordance with the acknowledgement mode, the receiving device 310 may additionally perform an automatic repeat request (ARQ) process. For example, the RLC layer 315-b of the receiving device 310 may support the ARQ functionality 340. Here, the RLC layer 315-b of the receiving device 310 may have a hole detection functionality 380, which may enable the receiving device 310 to detect holes (for example, to detect one or more RLC SDU segments 370 in a MAC PDU 350 that the receiving device 310 has failed to decode). In some cases, the receiving device 310 may detect holes based on a sequence number associated with the RLC SDU or RLC SDU segments 370 (for example, included in the RLC header 365), segmentation information associated with the RLC SDU or RLC SDU segments 370 (for example, included in the RLC header 365, included in the MAC sub-header 360), and/or a segment offset associated with the RLC SDU or RLC SDU segments 370 (for example, included in the RLC header 365, included in the MAC sub-header 360). In some instances, the receiving device 310 may detect the holes with or without assistance from a lower layer (for example, MAC/PHY layers 320-b of the receiving device 310).

The receiving device 310 may detect holes associated with a transmission of the MAC PDU 350 based on a timer (for example, a t-Reassembly timer). For example, the receiving device 310 may identify one or more missing RLC SDUs or RLC SDU segments 370 based on the sequence numbers associated with RLC SDUs or RLC SDU segments 370 that have been successfully received and decoded. The receiving device 310 may initiate the timer in response to identifying that one or more RLC SDUs or RLC SDU segments 370 are missing. If, prior to an expiration of the timer, the receiving device 310 does successfully receive and decode the one or more missing RLC SDUs or RLC SDU segments 370 (for example, as part of a HARQ process associated with the MAC PDU 350), then the receiving device 310 may reset the timer. Additionally, if the receiving device 310 does not successfully receive and decode the one or more missing RLC SDUs or RLC SDU segments 370 prior to the expiration of the timer, then the receiving device 310 may generate and transmit the status report 385 to the transmitting device 305.

In one example, the receiving device may detect holes as part of the RLC process in instances of a HARQ NACK to HARQ ACK error. In this example, the receiving device 310 may transmit a HARQ NACK to the transmitting device 305, and the transmitting device 305 may interpret the HARQ NACK as a HARQ ACK. As a result, the transmitting device 305 may terminate the HARQ process (for example, may stop HARQ transmissions and/or retransmissions for the MAC PDU 350).

In the example 300, the receiving device 310 may detect NACK to ACK errors prior to an expiration of the timer associated with the hole detection functionality 380 (for example, prior to the expiration of the t-Reassembly timer). In particular, the receiving device 310 may detect the NACK to ACK errors based on detecting an unsuccessful termination of a HARQ process (for example, due to a NACK to ACK error) associated with the MAC PDU 350. Then, the receiving device 310 may report the unsuccessful termination of the HARQ process associated with the MAC PDU 350 to the transmitting device 305. For example, the receiving device 310 may detect and report instances where a MAC PDU 350 associated with a HARQ process identifier is not decoded and the receiving device 310 receives another MAC PDU 350 associated with the same HARQ process identifier. Additionally, the receiving device 310 may detect and report instances where a MAC PDU 350 associated with a HARQ identifier is associated with an NDI value that is different from an expected value (for example, which may correspond to instances where the receiving device 310 previously failed to receive or decode control information scheduling another MAC PDU 350 associated with the same HARQ identifier and the other MAC PDU 350).

The status report 385 may be associated with a timer (for example, a t-StatusProhibit timer). Here, the receiving device 310 may refrain from transmitting the status report 385 until the timer expires. In some cases, the receiving device 310 waiting until the timer expires to transmit the status report 385 may decrease a periodicity associated with the receiving device 310 sending status reports 385. That is, after the receiving device 310 sends a status report 385, the receiving device 310 may reset and start (for example, initiate) the timer and may be unable to send another status report 385 until an expiration of the timer. The status report 385 may include RLC ACK and/or RLC NACK for certain sequence numbers (for example, associated with the MAC PDU 350).

The receiving device 310 may transmit a status report 385 in response to a polling request from the transmitting device 305. For example, the transmitting device 305 may include the polling functionality 330 at the RLC layer 315-a. In this example, the transmitting device may transmit, to the receiving device 310 (for example, via the RLC signaling 390, via the MAC/PHY signaling 375) a polling request triggering the receiving device 310 to transmit the status report 385 to the transmitting device 305. The transmitting device 305 may transmit the polling request based on a quantity of MAC PDUs 350 transmitted to the receiving device 310. For example, the transmitting device 305 may transmit the polling request after transmitting a certain quantity of MAC PDUs 350 (for example, as indicated by a variable such as a pollPDU variable). In another case, the transmitting device 305 may transmit the polling request based on a quantity of bytes transmitted (for example, via one or more MAC PDUs 350) to the receiving device 310. For example, the transmitting device 305 may transmit the polling request after transmitting a certain quantity of bytes (for example, as indicated by a variable such as a pollByte variable).

The receiving device 310 may transmit the status report 385 via the MAC/PHY signaling 375 or, in some other cases, via the RLC signaling 390. In response to receiving the status report 385, the transmitting device 305 may perform an ARQ process (for example, using the ARQ functionality 340 of the RLC layer 315-a). For example, the transmitting device 305 may retransmit any of the RLC SDU or RLC SDU segments 370 that correspond to a sequence number indicated as not successfully received and decoded in the status report 385. In some cases, the transmitting device 305 may continue transmitting retransmissions of any RLC SDUs or RLC SDU segments 370 until the receiving device 310 indicates that the RLC SDUs or RLC SDU segments 370 have been successfully received and decoded (for example, via an RLC ACK for the sequence numbers associated with the RLC SDUs or RLC SDU segments 370). Additionally, or alternatively, the transmitting device 305 may refrain from transmitting a retransmission of an RLC SDU or RLC SDU segment 370 in instances where a quantity of retransmissions associated with that RLC SDU or RLC SDU segment 370 is greater than a threshold (for example, a maxRetxThreshold).

As indicated above, FIG. 3 is provided as an example. Other examples may differ from what is described with regard to FIG. 3.

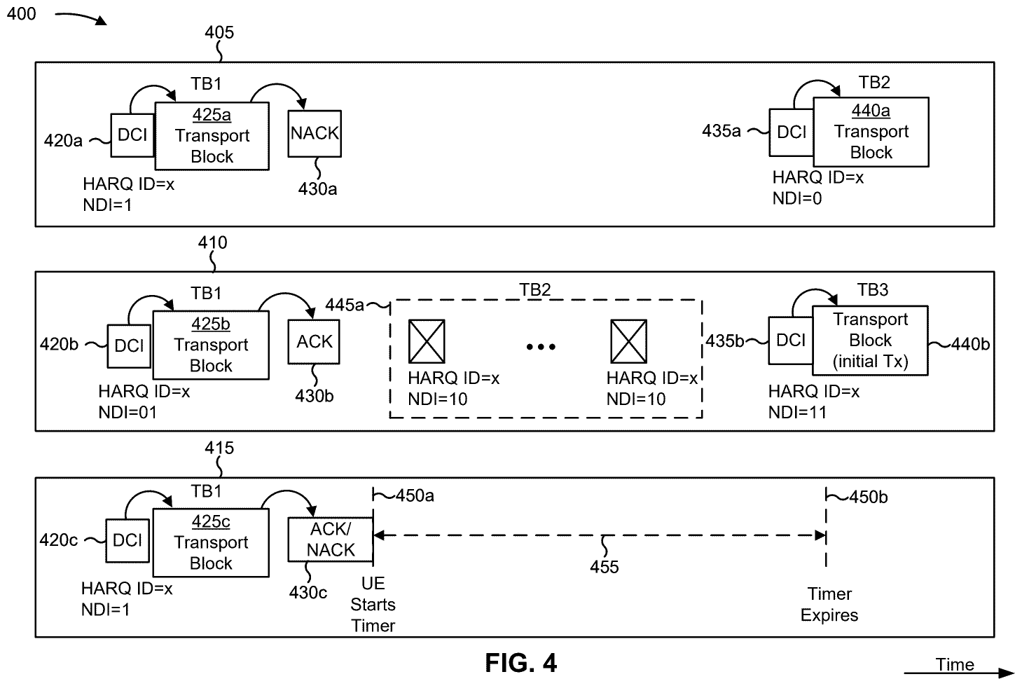

FIG. 4 is a diagram illustrating an example 400 associated with unsuccessful terminations of HARQ processes, in accordance with the present disclosure. The example 400 depicts a first event 405 indicative of an unsuccessful termination of a HARQ process, a second event 410 indicative of an unsuccessful termination of a HARQ process, and a third event 415 indicative of multiple potential unsuccessful terminations of a HARQ process. The example 400 depicts one or more signals received (or failed to be received, as indicated by the signals being depicted within a box having dashed lines) by a UE 120.

For example, for the first event 405, the UE 120 may receive DCI 420a that schedules the transmission of a transport block 425a (shown as TB1 in FIG. 4), The DCI 420a may indicate that the transport block 425a is associated with a HARQ identifier x and an NDI having a value of “1.” The UE 120 may not successfully receive and decode the transport block 425a, and may transmit a feedback communication 430a that includes a HARQ NACK indication (e.g., indicating that the transport block 425a was not successfully received or decoded by the UE 120). Later, the UE 120 may receive DCI 435a to schedule the transmission of a second (e.g., different) transport block 440a (shown as TB2 in FIG. 4). The DCI 435a may may indicate that the transport block 440a is associated with the same HARQ identifier as the transport block 425a (e.g., HARQ identifier x) and a different NDI value of “0” (e.g., the NDI indicated by the DCI 435a may have a different value than the NDI indicated by the DCI 420a to indicate that a new transport block is being communicated for the HARQ identifier x). The reception of the DCI 435a (scheduling a new transport block for the HARQ identifier x) may be indicative to the UE 120 of an unsuccessful termination of the HARQ process for the transport block 425a (e.g., and the HARQ identifier x) because the UE 120 may expect to receive a retransmission of the transport block 425a after transmitting the feedback communication 430a that includes the HARQ NACK indication. In some examples, the first event 405 may be caused by a NACK to ACK (N2A) error scenario (e.g., where the network node 110 incorrectly interprets a HARQ NACK indication as an HARQ ACK indication). Additionally, or alternatively, the first event 405 may be caused by the network node 110 refraining from retransmitting the transport block 425a (e.g., the network node 110 determines based on one or more conditions or factors to not retransmit the transport block 425a). In some examples, the first event 405 may be indicative a first type of an unsuccessful termination of HARQ event (e.g., referred to herein as a “type 1A” event).

As another example, for the second event 410, the UE 120 may receive DCI 420b that schedules the transmission of a transport block 425b (shown as TB1 in FIG. 4). The DCI 420b may indicate that the transport block 425b is associated with a HARQ identifier x and an NDI having a value of “01.” The UE 120 may successfully receive and/or decode the transport block 425b. Therefore, the UE 120 may transmit a feedback communication 430b that includes a HARQ ACK indication (e.g., indicating the successful decoding of the transport block 425b). Later, the UE 120 may receive DCI 435b to schedule the transmission of a second (e.g., different) transport block 440a (shown as TB3 in FIG. 4), and may indicate that the transport block 440b is associated with the same HARQ identifier as the transport block 425b (e.g., HARQ identifier x) and a different NDI value of “11” (e.g., the NDI indicated by the DCI 435b may have a different value than the NDI indicated by the DCI 420b). However, as shown in FIG. 4, the NDI value of the DCI 435b may be incremented from the NDI value of the DCI 420b by more than a single step value. For example, the UE 120 may expect that a next DCI for the HARQ identifier x will have a value of “10” after the UE 120 transmits the HARQ ACK indication. For example, as shown by reference number 445a, the UE 120 may fail to detect or receive one or more DCI communications (e.g., that include the expected NDI value of “10”) scheduling another transport block (shown as TB2 in FIG. 4) prior to receiving the DCI 435b. Therefore, the reception of the DCI 435b may be indicative of an unsuccessful termination of the HARQ process for the TB2. In some examples, the second event 410 may be caused by an N2A error scenario or a discontinuous transmission to acknowledgement (DTX2A) error. Additionally, or alternatively, the second event 410 may be caused by the network node 110 refraining from retransmitting the transport block 425b (e. g, the network node 110 determines based on one or more conditions or factors to not retransmit the transport block 425b). In some examples, the second event 410 may be indicative a second type of an unsuccessful termination of HARQ event (e.g., referred to herein as a “type 1B”event).

As another example, for the third event 415, the UE 120 may receive a DCI 420c that schedules the transmission of a transport block 425c (shown as TB1 in FIG. 4). The DCI 420c may indicate that the transport block 425c is associated with a HARQ identifier x and an NDI having a value of “1.” The UE 120 may transmit a feedback message 430c in response to the transport block 425c. In a first case of the third event 415, the UE 120 may not successfully receive and/or decode the transport block 425c. Therefore, the UE 120 may transmit the feedback communication 430c that includes a HARQ NACK indication (e.g., indicating that the transport block 425c was not successfully received and/or decoded by the UE 120). In a second case of the third event 415, the UE 120 may successfully receive and decode the transport block 425c. Therefore, the UE 120 may transmit the feedback communication 430c that includes a HARQ ACK indication (e.g., indicating the successful decoding of the transport block 425c). Additionally, as illustrated in FIG. 4 with reference to the third event 415, the UE 120 may start (e.g., initiate) a timer at time 450a in response to transmitting the feedback communication 430c (e.g., independent of whether the feedback communication 430c includes a HARQ NACK indication or HARQ ACK indication). For example, the network node 110 may configure the UE 120 with a timer for identifying potential unsuccessful terminations of HARQ processes. In particular, the network node 110 may indicate for the UE 120 to identify an unsuccessful HARQ process termination in response to an expiration of the timer. The network node 110 may transmit signaling to the UE 120 configuring a value for the timer (e.g., duration 455). For example, the network node 110 may transmit signaling (e.g., via RRC signaling) indicating the value for the timer (e.g., the value of duration 455). In some examples, the network node 110 may configure the UE 120 with multiple timers associated with multiple respective durations 455. For instance, the network node 110 may configure the UE 120 with a first timer for the UE 120 to use if the feedback communication 430c includes a HARQ NACK indication, and a second timer for the UE 120 to use if the feedback communication 430c includes a HARQ ACK indication. Additionally, or alternatively, the network node 110 may configure the UE 120 with multiple timers associated with multiple respective HARQ identifiers, where the UE 120 determines to initiate the timer associated with HARQ identifier x, based on transport block 425c being associated with the HARQ identifier x.

As described herein, the third event 415 may be indicative of multiple types of potential unsuccessful termination of the HARQ process. In a first example, the UE 120 may transmit a HARQ NACK indication in response to the transport block 425c, start the timer at time 450a, and identify expiration of the timer at a time 450b. In such a first example, the UE 120 may anticipate reception of a retransmission of transport block 425c prior to expiration of the timer (e.g., based on transmission of the HARQ NACK). However, one or more scenarios may cause the UE 120 to not receive the retransmission of transport block 425c prior to timer expiration. For example, the UE 120 may have failed to receive one or more subsequent DCIs scheduling the retransmission of transport block 425c, or the network node 110 may have refrained from scheduling subsequent transport blocks using the HARQ identifier x for a duration of time above a threshold. Alternatively, the network node 110 may have scheduled retransmission of the transport block 425c at a time that is after the timer expires (e.g., not an actual unsuccessful HARQ termination). Therefore, the expiration of the timer after transmission of a HARQ NACK indication may be indicative of a potential type of unsuccessful termination of the HARQ process (e.g., referred to herein as a “type 2A” event).

In a second example of the third event 415, the UE 120 may transmit a HARQ ACK indication in response to the transport block 425c, start the timer at time 450a, and identify expiration of the timer at the time 450b. In such a second example, the UE 120 may anticipate reception of a second transport block (e.g., based on indicating successful reception and decoding of transport block 425c via the HARQ ACK indication) prior to expiration of the timer. However, one or more scenarios may cause the UE 120 to not receive the second transport block prior to timer expiration. For example, the UE 120 may have failed to receive one or more subsequent DCIs scheduling the transmission of the second transport block, or the network node 110 may have refrained from scheduling subsequent transport blocks using the HARQ identifier x for a duration of time that is greater than the duration 455. Alternatively, the network node 110 may have scheduled the second transport block at a time that is after the timer expires (e.g., not an actual unsuccessful HARQ termination). Therefore, the expiration of a timer after transmission of a HARQ ACK indication may be indicative of a potential type of unsuccessful termination of the HARQ process (e.g., referred to herein as a “type 2B” event).

As described herein, there may be multiple types of unsuccessful or potentially unsuccessful HARQ termination events. For instance, in the case of the first event 405 and second event 410 (which respectively refer to a type 1A event and a type 1B event), the UE 120 may identify a unsuccessful HARQ event based on reception of subsequent DCI that includes information associated with the HARQ process that is unanticipated by the UE 120 (e.g., an NDI value that is suggests miscommunication between the network node 110 and the UE 120). Additionally, or alternatively, in the case of the third event 415 (which refers to a type 2A event and a type 2B event), the UE 120 may identify a potential unsuccessful HARQ event based on expiration of a timer that the UE 120 starts in response to transmission of feedback communication 430c.

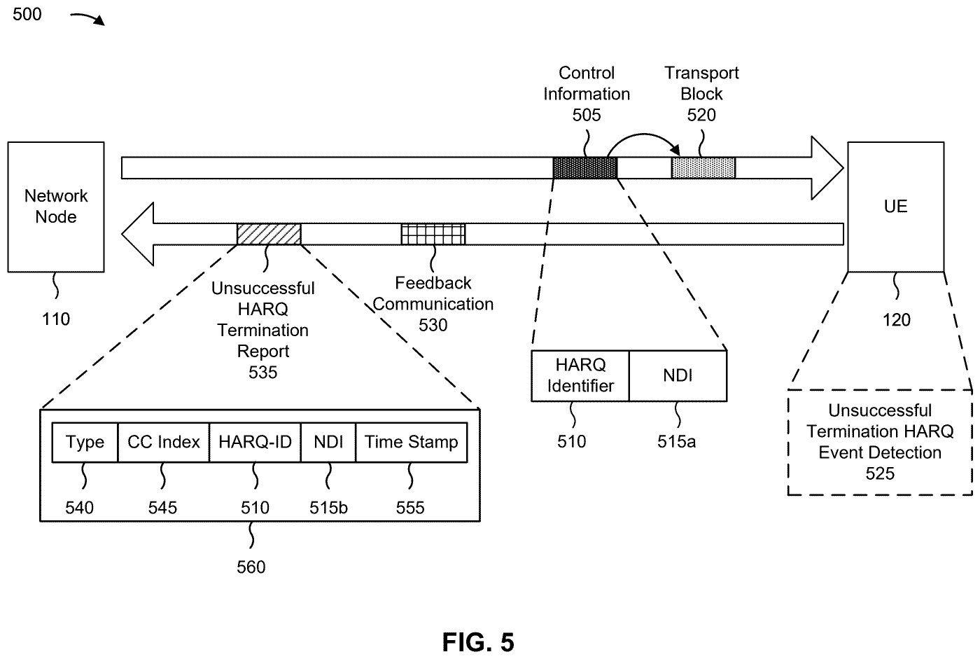

In accordance with identifying an unsuccessful or potentially unsuccessful HARQ termination event, the UE 120 may transmit an unsuccessful HARQ termination report to the network node 110. In some examples, the unsuccessful HARQ termination report may include information associated with a transport block that corresponds to the unsuccessful HARQ termination event. In such examples, the network node 110 may use the included information to determine a HARQ resolution procedure such that the UE 120 may successfully receive and decode the transport block and so the network node 110 and UE 120 may successfully terminate the HARQ process associated with the transport block. In some cases, however, the information included in the unsuccessful HARQ termination report may be based on the type of unsuccessful HARQ termination event the UE 120 identifies (e.g., Type 1A, Type 1B, Type 2A, or Type 2B). Therefore, in some examples, the network node 110 may misinterpret the information included in the unsuccessful HARQ termination report because the network node 110 may not receive an indication of the type of unsuccessful HARQ termination event that caused the UE 120 to transmit the unsuccessful HARQ termination report. Further discussion of the information included and/or indicated in the unsuccessful HARQ termination report are described herein, including with reference to FIG. 5.

As indicated above, FIG. 4 is provided as an example. Other examples may differ from what is described with regard to FIG. 4.

FIG. 5 is a diagram illustrating an example 500 associated with resolution of unsuccessful terminations of HARQ processes, in accordance with the present disclosure. The example 500 may implement or be implemented by one or more of wireless communication network 100, disaggregated network node architecture 200, example 300, or example 400. For example, example 500 depicts one or more signals communicated between the UE 120 and network node 110 in accordance with detecting and indicating a type of unsuccessful HARQ termination event (e.g., type 1A event, type 1B event, type 2A event, or type 2B event). As such, the indication of the event type may be used in accordance with the techniques described herein to facilitate a resolution of an unsuccessful termination for a HARQ process (e.g., a HARQ process ID).

In some aspects, the UE 120 may transmit, and the network node 110 may receive, capability information. The capability information may be included in a capability report. The UE may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, an RRC communication, a physical uplink control channel (PUCCH), a physical uplink shared channel (PUSCH), a physical sidelink control channel (PSCCH), and/or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for indicating a type associated with the unsuccessful HARQ termination event detected at the UE 120 (e.g., type 1A event, type 1B event, type 2A event, or type 2B event). As another example, the capability information may indicate a capability and/or parameter for detecting the unsuccessful HARQ termination event associated with a HARQ process and further detecting that the unsuccessful HARQ termination event is associated with the type.

One or more operations described herein may be based on capability information. For example, the UE may perform a communication in accordance with the capability information, or may receive configuration information that is in accordance with the capability information. In some aspects, the capability information may indicate UE support for transmitting unsuccessful HARQ termination report 535 that indicates a type 540 associated with the detected unsuccessful HARQ termination event. In some aspects, the capability information may indicate UE support for indicating the type 540 in a header of the unsuccessful HARQ termination report 535. In some aspects, the capability information may indicate UE support for indicating the type 540 in a field of the unsuccessful HARQ termination report 535. In some aspects, the capability information may indicate UE support for indicating multiple unsuccessful HARQ termination events in the unsuccessful HARQ termination report 535, where the multiple unsuccessful HARQ termination events each are associated with a same type 540 or respective types 540.

In some aspects, the network node may transmit, and the UE may receive, configuration information. In some aspects, the UE may receive the configuration information via one or more of system information signaling (e.g., a master information block (MIB) and/or a system information block (SIB), among other examples), RRC signaling, MAC signaling (e.g., one or more MAC-CEs), and/or lower layer signaling (e.g., DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to configured to transmit the unsuccessful HARQ termination report 535 that indicates the type 540 associated with the detected unsuccessful HARQ termination event.

The UE 120 may configure itself based at least in part on the configuration information. In some aspects, the UE 120 may be configured to perform one or more operations described herein based at least in part on the configuration information.

As illustrated in FIG. 5, the network node 110 may transmit, and the UE 120 may receive, control information 505 (e.g., a DCI) that schedules the transmission of a transport block 520. The control information 505 may indicate that the transport block 520 is associated with a HARQ identifier 510 (e.g., identified by a HARQ process ID) and an NDI 515a. In some examples, the UE 120 may perform an unsuccessful HARQ termination event detection 525 based on receiving the control information 505. For example, the unsuccessful HARQ termination event detection 525 may be associated with at least one of the first event 405, the second event 410, and or third event 415, as described with reference to FIG. 4. With reference to the first event 405, the control information 505 may be an example of DCI 435a. In such examples, the unsuccessful HARQ termination event detection 525 may be based on UE 120 expecting to receive a retransmission of the transport block 425a after transmitting the feedback communication 430a that includes the HARQ NACK indication (e.g., type 1A event). With reference to the second event 410, the control information 505 may be an example of DCI 435b. In such examples, the unsuccessful HARQ termination event detection 525 may be based on the NDI 515a of control information 505 being incremented by more than a single step value relative to a previous DCI (e.g., type 1B event).

With reference to the third event 415, the control information 505 may be an example of DCI 420c. In a first example of the third event 415, the UE 120 may receive the control information 505 and start a timer after transmitting a feedback communication 530 that includes a HARQ NACK indication. In such examples, the unsuccessful HARQ termination event detection 525 is based on expiration of the timer prior to receiving a retransmission of the transport block 520 (e.g., type 2A event). In a second example of the third event 415, the UE 120 may receive the control information 505 and start a timer after transmitting the feedback communication 530 that includes a HARQ ACK indication. In such examples, the unsuccessful HARQ termination event detection 525 is based on expiration of the timer prior to receiving a transmission of a second transport block that is subsequent to transport block 520 (e.g., type 2B event).

As described, the unsuccessful HARQ termination event detection 525 may be triggered based on reception of control information 505 and/or expiration of a timer. Additionally, the unsuccessful HARQ termination event detection 525 may identify a type associated with the unsuccessful HARQ termination event (e.g., one of type 1A event, type 1B event, type 2A event, or type 2B event). After (e.g., based on, in response to, or otherwise associated with) identifying (e.g., detecting) the unsuccessful HARQ termination event the UE 120 may transmit an unsuccessful HARQ termination report 535. In some examples, the unsuccessful HARQ termination report 535 may be a MAC-CE based report (as part of an uplink transport block the UE 120 transmits via PUSCH or PUCCH). The unsuccessful HARQ termination report 535 may be a MAC-CE report based on the unsuccessful HARQ termination report 535 being event triggered and the reliability associated with MAC based signaling. However, the unsuccessful HARQ termination report 535 may alternatively be an example of uplink RRC signaling or a UCI message (as part of an uplink transport block the UE 120 transmits via PUSCH or PUCCH).

As depicted in FIG. 5, the unsuccessful HARQ termination report 535 may include a block 560 corresponding to (e.g., identifying information associated with) the unsuccessful HARQ termination event detected by the UE 120. Additionally, the block 560 may indicate information associated with the unsuccessful HARQ termination event. For example, the block 560 may indicate one or more of a CC index (e.g., associated with the CC used for communication of the control information 505 and/or the transport block 520), a HARQ identifier (e.g., the HARQ identifier 510 indicated in the control information 505), an NDI 515b (e.g., that is the same or different as the NDI 510a based on the event type detected), or a time stamp 555 (e.g., an indication of a slot, subslot, symbol, transmission time interval (TTI), frame, subframe, or minislot associated with identification the unsuccessful HARQ termination event). The network node 110 may use the information included in the block 560 to determine which of multiple actions to perform to achieve resolution of the unsuccessful HARQ termination event associated with transport block 520. In some examples, the network node 110 may attempt to retransmit the entirety of transport block 520 in an updated HARQ process (e.g., resets the HARQ process and sends the transport block 520 again, treating it as a new transmission attempt). In some examples, the network node 110 may attempt to retransmit the transport block 520 using different resources and/or coding schemes (e.g., retransmit the transport block 520 on different time and frequency resources and/or use a different MCS), which may improve reliability. Additionally, or alternatively, while FIG. 5 depicts the unsuccessful HARQ termination report 535 as including a single block 560 associated with a single unsuccessful HARQ termination event, it is understood that the unsuccessful HARQ termination report 535 may include multiple blocks 560 associated with multiple respective unsuccessful HARQ termination events.

In some examples, the information included in the block 560 may be different for different types of unsuccessful HARQ termination events. Additionally, or alternatively, an interpretation of the information included in the report may be different for different types of unsuccessful HARQ termination events. For example, the time stamp 555 may be different for different types of events. For instance, for event type 1A or event type 1B, the time stamp 555 may be the slot (or any other time increment or time interval described herein) where the control information 505 is detected or received by the UE 120 (e.g., DCI 435a for event type 1A and DCI 435b for event type 1B, with reference to FIG. 4). Additionally, for event type 2A or event type 2B, the time stamp 555 may be the slot (or any other time increment or time interval described herein) during which the timer expires (e.g., time 450b, with referent to FIG. 4). In some examples, the unsuccessful HARQ termination report 535 may include the time stamp 555 to reduce confusion if the MAC-CE based reporting is associated with multiple PUSCH HARQ retransmissions on the uplink. Additionally, or alternatively, the NDI 515b included in the unsuccessful HARQ termination report 535 may be dependent on the event type. For instance, for event type 1A or event type 2A, the NDI 515b is based on the NDI of the latest detected DCI, such as DCI included in the control information 505 (e.g., the NDI indicated in DCI 420a for event type 1A and the NDI indicated in DCI 420c for event type 2A, with reference to FIG. 4). Additionally, for event type 1B or event type 2B, the NDI 515b is based on the NDI of the latest detected DCI, incremented by 1 (e.g., the NDI indicated in DCI 420b+1 for event type 1B and the NDI indicated in DCI 420c+1 for event type 2B, with reference to FIG. 4). For event type 1B and event type 2B, the NDI is incremented by 1 to indicate to the network node 110 the missed NDI value (e.g., the NDI expected for TB2 in the second event 410 of FIG. 4) rather than the NDI value of the detected DCI. That is, incrementing the NDI by 1 enables the network node 110 to identify the transport block missed by the UE 120.

As such, the interpretation of the information included in the unsuccessful HARQ termination report 535 by the network node 110 is dependent on the type of event (e.g., type 1A event, type 1B event, type 2A event, or type 2B event).

According to the techniques described herein, the UE 120 may distinguish between the different types of events for a reported unsuccessful (or potentially unsuccessful) HARQ termination event. For example, as depicted in FIG. 5, the unsuccessful HARQ termination report 535 may indicate a type 540, where the value of one or more fields of the unsuccessful HARQ termination report 535 (e.g., the time stamp 555 and/or the NDI 515b) are dependent on the indicated type 540. Additionally, or alternatively, the presence or absence of one or more fields (e.g., the time stamp 555 and/or the NDI 515b) may be dependent on the indicated type 540. The type 540 may indicate one or more types of an unsuccessful HARQ termination event. In some examples, the type 540 may indicate a single type of an unsuccessful HARQ termination event (e.g., event type 1A, event type 1B, event type 2A, or event type 2B). In other examples, the type 540 may indicate a category of types of unsuccessful HARQ termination events. In such examples, a category may include multiple types of unsuccessful HARQ termination events.

In a first example, the type 540 may distinguish between a set of types (e.g., the four types described in connection with FIG. 4, as an example) of an unsuccessful HARQ termination event (e.g., distinguish between each of type 1A event, type 1B event, type 2A event, and type 2B event). For example, the type 540 may be a field that indicates two bits, where the multiple values of the two bits correspond to the multiple respective event types (e.g., value “00” indicated by type 540 indicates the type 1A event, value “01” indicated by type 540 indicates the type 1B event, value “10” indicated by type 540 indicates the type 2A event, value “11” indicated by type 540 indicates the type 2B event, or some other variation of bit value and event type correspondence). In such a first example, the value of the time stamp 555 and the value of the NDI 515b may be dependent on the indicated type 540 (e.g., in accordance with examples provided above). By operating in accordance with the first example, the unsuccessful HARQ termination report 535 may differentiate between each of the four types of an unsuccessful termination of a HARQ event, which may provide an increase in clarity at the network node 110 for interpreting the time stamp 555 and/or the NDI 515b. Such an increase in clarity may increasing efficiency for resolution of the unsuccessful HARQ termination event.

In other examples, the type 540 may distinguish between a first category of event types and a second category of event types. In a second example, the type 540 may distinguish between event type 1A/1B (e.g., where the unsuccessful HARQ termination event detection 525 is based on reception of a subsequent DCI) and event type 2A/2B (e.g., where the unsuccessful HARQ termination event detection 525 is based on expiration of the timer). For example, the first category may include the event type 1A and the event type 1B and the second category may include the event type 2A and the event type 2B. For example, the type 540 may be a field that indicates one of two possibilities (via one bit), where the two possible values of the one bit correspond to the distinguished event types (e.g., value “0” of type 540 indicates the type 1A/1B event and value “1” of type 540 indicates the type 2A/2B event, or vice versa). That is, the value of the type 540 may indicate whether the unsuccessful HARQ termination event is a result of the UE 120 detecting a subsequent DCI (e.g., type 1A/1B event) or a result of a timer expiry at the UE 120 (e.g., type 2A/2B event). Additionally, or alternatively, the type 540 may indicate whether the unsuccessful HARQ termination event is a certified unsuccessful HARQ termination (e.g., type 1A/1B event) or a potential unsuccessful HARQ termination (e.g., type 2A/2B event). In such examples, the first category may be associated with certified (e.g., detected or confirmed) unsuccessful HARQ termination events (e.g., type 1A/1B event) and the second category may be associated with potential unsuccessful HARQ termination events (e.g., type 2A/2B event). In such a second example, the value of the time stamp 555 is dependent on the type 540 indicated. By operating in accordance with the second example, the UE 120 may reduce the bit size associated with type 540 while maintaining information for the network node 110 to determine how to interpret the time stamp 555. For example, if the type 540 indicates the event type 1A/1B, then the network node 110 may identify that the time stamp 555 indicates a time (e.g., a slot) at which the UE 120 received control information 505. Alternatively, if the type 540 indicates event type 2A/2B, then the network node 110 may identify that the time stamp 555 indicates a time (e.g., a slot) wat which the timer expired at the UE 120 (e.g., time 450b, with reference to FIG. 4).

Additionally, or alternatively, in accordance with the second example, the UE 120 may determine to refrain from including the NDI 515b, which may further reduce the size of the unsuccessful HARQ termination report 535, which may further reduce signaling complexity and signaling overhead. The UE 120 may refrain from including the NDI 515b based on the type 540 differentiating between event type 1A/1B and event type 2A/2B, where such a differentiation may not utilize NDI as category of information to assist the network node 110 in resolution.

In a third example, the type 540 may distinguish between event type 1A/2A (e.g., where the unsuccessful HARQ termination event detection 525 is after transmission of feedback communication 530 that includes a HARQ NACK indication) and event type 1B/2B (e.g., where the unsuccessful HARQ termination event detection 525 is after transmission of feedback communication 530 that includes a HARQ ACK indication). For example, the first category may be associated with unsuccessful HARQ termination event detection after the transmission of feedback communication 530 that includes a HARQ NACK indication (e.g., event type 1A and event type 2A) and the second category may be associated with unsuccessful HARQ termination event detection after the transmission of feedback communication 530 that includes a HARQ ACK indication (e.g., event type 1B and event type 2B). For example, the type 540 may be a field that indicates one of two possibilities (via one bit), where the two possible values of the one bit correspond to the distinguished event types (e.g., value “0” of type 540 indicates the type 1A/2A event and value “1” of type 540 indicates the type 1B/2B event, or vice versa). That is, the value of the type 540 may indicate whether the event for the HARQ identifier 510 is detected after HARQ NACK indication (e.g., type 1A/2A event) or a HARQ ACK indication (e.g., type 1B/2B event) for the latest instance of the HARQ identifier 510. In such a third example, the value of the NDI 515b may be dependent on the type 540 indicated. By operating in accordance with the third example, the UE 120 may reduce the bit size associated with type 540 while maintaining information for the network node 110 to determine how to interpret the NDI 515b. Additionally, or alternatively, in accordance with the third example, the UE 120 may refrain from including the time stamp 555, which may further reduce the size of the unsuccessful HARQ termination report 535, which may further reduce signaling complexity and signaling overhead.

By indicating the type 540 in the unsuccessful HARQ termination report 535 (e.g., in accordance with the first example, the second example, or the third example), the UE 120 may reduce misinterpretation at the network node 110, which may result in faster resolution of the unsuccessful HARQ termination event, decreasing latency without increasing signal overhead.

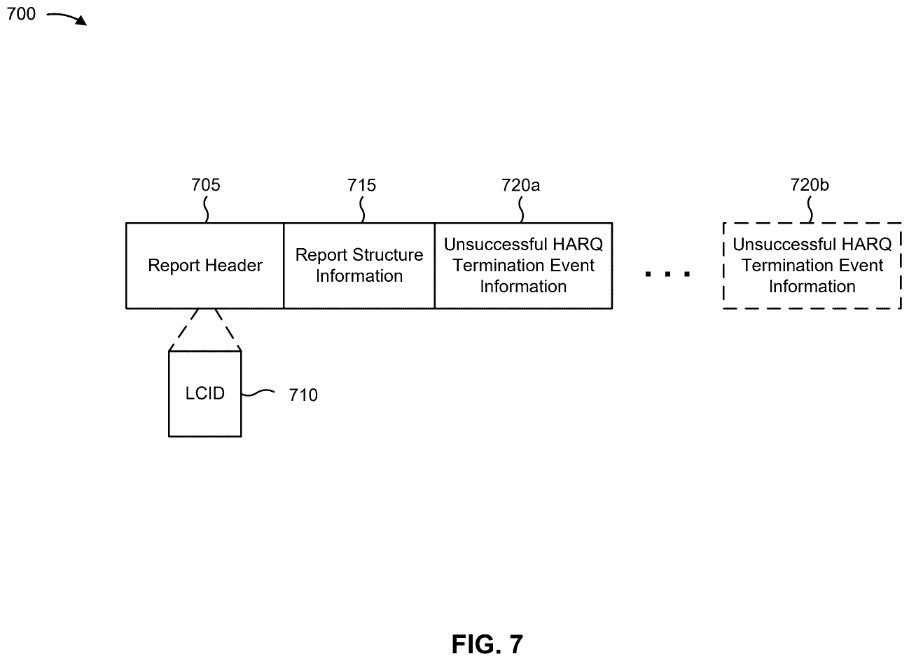

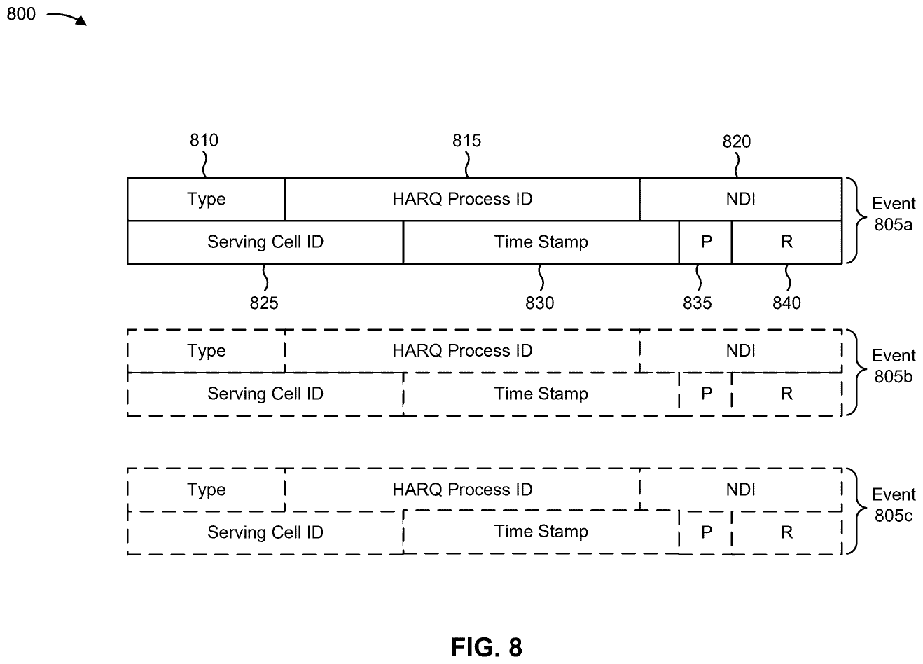

In some examples, a header of the unsuccessful HARQ termination report 535 may indicate the type 540. Further discussion of the header indicating the type 540 is described herein, including with reference to FIG. 7. In some examples, a field of the unsuccessful HARQ termination report 535 may indicate the type 540. Further discussion of the field indicating the type 540 is described herein, including with reference to FIG. 8.

In accordance with receiving the unsuccessful HARQ termination report 535, the network node 110 may perform one or more actions to achieve resolution of the indicated unsuccessful HARQ termination event. For example, the network node 110 may process the unsuccessful HARQ termination report 535 transmitted by the UE 120 and identify the transport block that failed to be successfully received and/or decoded. This identification may be based on the information contained in the unsuccessful HARQ termination report 535, and one or more fields (e.g., time stamp 555 and/or NDI 515b) may be interpreted based on the type 540 indicated. Upon identification of the failed HARQ process, the network node 110 determines whether to retransmit the transport block. This determination may involve initiating a full retransmission of the transport block (e.g., treating the data as a new transmission while resetting the HARQ process). Additionally, or alternatively, the network node 110 may choose to modify the MCS used for the retransmission (e.g., a more robust MCS, typically involving lower-order modulation, may be selected to increase the likelihood of successful decoding by the UE 120). In some examples, the network node 110 allocates updated transmission resources for the retransmission of the transport block. This allocation may include time-frequency resource blocks that are dynamically selected to reduce interference for retransmission. Additionally, the network node 110 may schedule the retransmission based on the resource availability and network conditions, ensuring that the retransmission occurs in a timely manner. By operating in such techniques, the UE 120 may successfully receive and decode the retransmission resulting in resolution of the unsuccessful HARQ termination event indicated in the unsuccessful HARQ termination report 535.

As indicated above, FIG. 5 is provided as an example. Other examples may differ from what is described with regard to FIG. 5.

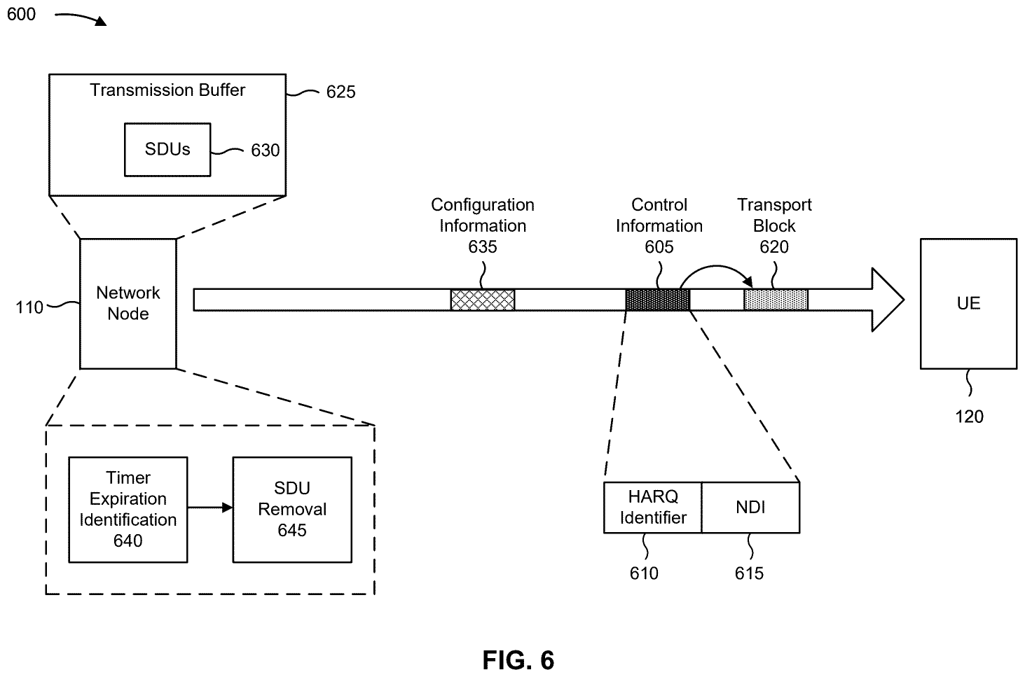

FIG. 6 is a diagram illustrating an example 600 associated with resolution of unresolved HARQ processes, in accordance with the present disclosure. The example 600 may implement or be implemented by one or more of wireless communication network 100, disaggregated network node architecture 200, example 300, example 400, or example 500. For example, example 600 depicts one or more signals communicated between the UE 120 and network node 110 in accordance with a HARQ process of a transport block 620.

In some aspects, the UE 120 may transmit, and the network node 110 may receive, capability information. The capability information may be included in a capability report. The UE may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, an RRC communication, a physical uplink control channel (PUCCH), a physical uplink shared channel (PUSCH), a physical sidelink control channel (PSCCH), and/or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for indicating a type associated with the unsuccessful HARQ termination event detected at the UE 120 (e.g., type 1A event, type 1B event, type 2A event, or type 2B event). As another example, the capability information may indicate a capability and/or parameter for detecting the unsuccessful HARQ termination event associated with a HARQ process and further detecting that the unsuccessful HARQ termination event is associated with the type. One or more operations described herein may be based on capability information. For example, the UE may perform a communication in accordance with the capability information, or may receive configuration information that is in accordance with the capability information. In some aspects, the capability information may indicate UE support for initiating one or more timers after transmission of feedback communication associated with a HARQ process (e.g., timers associated with type 1B event and/or type 2B event).

In some aspects, the network node may transmit, and the UE 120 may receive, configuration information 635. In some aspects, the UE 120 may receive the configuration information 635 via one or more of system information signaling (e.g., a master information block (MIB) and/or a system information block (SIB), among other examples), RRC signaling, MAC signaling (e.g., one or more MAC-CEs), and/or lower layer signaling (e.g., DCI), among other examples.

In some aspects, the configuration information 635 may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information 635 may not be expressly signaled to the UE 120. For example, in some aspects, the configuration information may at least partially be defined by a wireless communication standard, such as the 3GPP. In such examples, the network node 110 may not explicitly indicate such configuration information 635 to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information 635 may indicate that the UE 120 is to configured to transmit the unsuccessful HARQ termination report that indicates the type associated with the detected unsuccessful HARQ termination event. In some aspects, the configuration information 635 may indicate that the UE 120 is to configured to initiate the one or more timers indicated in the configuration information 635 after transmission of a feedback communication associated with a HARQ process.

The UE 120 may configure itself based at least in part on the configuration information 635. In some aspects, the UE 120 may be configured to perform one or more operations described herein based at least in part on the configuration information.

As illustrated in FIG. 6, the UE 120 may receive control information 605 (e.g., a DCI) that schedules the transmission of a transport block 620. The control information 605 may indicate that the transport block 620 is associated with a HARQ identifier 610 and an NDI 615. In some examples, the transport block 620 may include one or more SDUs 630. As described with reference to FIG. 3, an SDU may represent the data passed from a higher layer (e.g., RLC layer) to a lower layer (e.g., the MAC layer and/or PHY layer) for transmission or processing. Additionally, an SDU may serve to ensure the efficient handling of both user and control plane data in the 5G protocol stack. In some examples, each protocol layer processes SDUs received from the upper layer and encapsulates or segments the SDUs into PDUs for transmission to the next lower layer. The SDUs maintain the integrity of the original data while allowing each layer to add or modify information to fulfill respective tasks. In some examples, the SDUs 630 may be examples of one or more RLC SDUs, one or more SDU segments, or both.

As illustrated in FIG. 6, the network node 110 may store the SDUs 630 (included in the transport block 620) in a transmission buffer 625 of the network node 110. For example, the network node 110 may store the SDUs 630 in the transmission buffer 625 (e.g., an L2 buffer) such that if the UE 120 transmits a NACK indication (e.g., an RLC NACK indication) associated with the transport block 620, then the network node 110 may use the one or more SDUs 630 stored at the transmission buffer 625 to generate a retransmission of the transport block 620 (e.g., a partial retransmission of the contents of the transport block 620 or a total retransmission of the transport block 620). As such, the network node 110 may maintain the SDUs 630 included in the transport block 620 until reception of an ACK indication (e.g., RLC ACK indication) from the UE 120 indicating successful reception and decoding of the transport block 620. However, while waiting for the UE 120 to transmit the ACK indication, the network node 110 maintains the one or more SDUs in the transmission buffer, which may reduce storage capacity and storage efficiency at the network node 110.

According to the techniques described herein, the network node 110 may determine to remove (e.g., delete or discard) the one or more SDUs 630 from the transmission buffer 625, if the network node 110 does not receive a NACK indication or an unsuccessful HARQ termination report (e.g., for any of the type 1A event, type 1B event, type 2A event, or type 2B event) associated with the transport block 620 prior to expiration of a time period. That is, the network node 110 may determine that the UE 120 successfully received and decoded the transport block 620 based on a lack of a feedback communication (e.g., based on not receiving a NACK indication or an unsuccessful HARQ termination report). As such, the network node 110 may assume that the SDUs 630 associated with the transport block are successfully delivered to the UE 120.

In some examples, the time period that the network node 110 waits prior to removing the SDUs 630 may be based on the one or more timers (e.g., network configured timers). For example, the network node 110 may transmit to the UE 120 configuration information 635 that indicates one or more timers for use at the UE 120 in accordance with HARQ processes. For instance, the one or more timers may be examples of the one or more timers associated with the third event 415, as described with reference to FIG. 4 (e.g., one or more timers initiated by the UE 120 after transmission of a feedback communication for potential detection of the type 2A event and/or type 2B event). As such, the value of the one or more timers indicated in the configuration information 635 may determine how long the network node 110 determines to wait before determining that a lack of feedback communication from the UE 120 may implicitly indicate a ACK indication. That is, the network node 110 may interpret a lack of an RLC NACK indication as an RLC ACK indication (such that the network node 110 may flush the transmission buffer 625). Additionally, or alternatively, the time period the network node 110 waits prior to removing the SDUs 630 may be based on latency associated with wireless communications. For example, if the network node 110 initiates the time period in response to transmitting the transport block 620, the network node 110 may account for latency associated with downlink transmission of the transport block, latency associated with receiving uplink feedback communication from the UE 120 (e.g., uplink latency for the MAC-CE report), or a combination thereof. That is, the time period the network node 110 waits prior to removing SDUs 630 from the transmission buffer 625 may be based on one or more timers configured at the UE 120 (e.g., via configuration information 635 for type 2A event and type 2B event), latency associated with wireless communications, or both.

As described herein, the network node 110 may perform a timer expiration identification 640 if the time period initiated by the network node 110 (after transmission of the transport block 620) expires prior to receiving feedback communication from the UE 120 associated with the transport block 620. In accordance with the timer expiration identification 640, the network node 110 may perform SDU removal 645, where the network node 110 removes the SDUs 630 included the transport block 620 from the transmission buffer 625. The described techniques of example 600 may be used to decrease storage use at the transmission buffer 625 of the network node 110. For example, by removing SDUs 630 from the transmission buffer 625 after a defined period of time, the network node 110 may reduce the use of storage resources without relying on explicit signaling from the UE 120. Additionally, such techniques may allow the network node 110 to refrain from transmitting to the UE 120 a network triggered status report (e.g., via polling mechanism in RLC acknowledged mode (AM)), which may further reduce signaling overhead while also conserving memory resources of the network node 110.

As indicated above, FIG. 6 is provided as an example. Other examples may differ from what is described with regard to FIG. 6.

FIG. 7 is a diagram illustrating an example 700 of an unsuccessful HARQ termination report, in accordance with the present disclosure. The example 700 may implement or be implemented by one or more of wireless communication network 100, disaggregated network node 110 architecture 200, example 300, example 400, example 500, or example 600. For instance, example 700 depicts a structure of the unsuccessful HARQ termination report 535, as described with reference to FIG. 5. In some examples, the UE 120 may transmit to the network node 110 the report depicted in example 700 to indicate a type of unsuccessful HARQ termination event associated with one or more detected unsuccessful HARQ termination events. In the example 700, the unsuccessful HARQ termination report may be a MAC-CE report that the UE 120 transmits in a transport block via PUSCH or PUCCH. However, it is understood that the unsuccessful HARQ termination report may be of other signaling types (e.g., RRC signaling or UCI).

As illustrated in FIG. 7, the example 700 may include a report header 705. In some examples, the report header 705 may include information that helps the network node 110 interpret the payload of the unsuccessful HARQ termination report. The one or more fields included in the report header 705 may depend on the type of report (e.g., a type of MAC-CE). For example, as depicted in FIG. 7, the report header 705 may include at least a logical channel identifier (LCID) 710. The LCID 710 may be a bit field (e.g., 5 bits) that identifies the type of report the UE 120 is transmitting. For instance, different values in the LCID 710 may indicate different types of MAC-CE reports, such as a power headroom report (PHR), a buffer status report (BSR), a scheduling request (SR), and/or a timing advance command (TAC), among other examples. The report header 705 may include additional fields, such as one or more of a format indicator (e.g., a bit field used to indicate whether the header is followed by additional fields), a length field (e.g., a quantity of bits that indicate the length of the control information or payload), one or more reserved bits (e.g., a quantity of bits that are reserved for future use or to ensure proper alignment of the report, associated with a predefined value with no active role in the function of the control element), and/or padding (e.g., may be included to ensure that the MAC-CE is byte-aligned), among other fields.

As described herein, the LCID 710 may indicate different types of MAC-CE reports. In accordance with techniques described herein, the UE 120 and/or network node 110 may leverage the different LCIDs that are associated with different types of MAC-CE reports to indicate the different types of unsuccessful HARQ termination event (e.g., type 1A event, type 1B event, type 2A event, or type 2B event). That is, the LCID 710 may directly indicate or be indicative of the type 540, as described with reference to FIG. 5. For example, based on receiving the unsuccessful HARQ termination report depicted in example 700, the network node 110 may determine the type of unsuccessful HARQ termination event in accordance with the LCID 710 included in the report header 705. In some examples, the LCID 710 may differentiate between each of the four event types (e.g., type 1A event, type 1B event, type 2A event, or type 2B event). In some examples, the LCID 710 may differentiate between event type 1A/1B and event type 2A/2B (e.g., distinguish between unsuccessful HARQ termination event detected based on a subsequent DCI and detected based on expiration of a timer at the UE 120). In some examples, the LCID 710 may differentiate between event type 1A/2A and event type 1B/2B (e.g., distinguish between unsuccessful HARQ termination event detected after transmission of a HARQ NACK indication and detected after transmission of a HARQ ACK indication).

As depicted in example 700, the unsuccessful HARQ termination report may include unsuccessful HARQ termination event information 720a. In some cases, the unsuccessful HARQ termination event information 720a may be an example of the block 560, as described with reference to FIG. 5. For example, the unsuccessful HARQ termination event information 720a may indicate information associated with the unsuccessful HARQ termination event, including one or more of a CC index, a HARQ identifier, an NDI, and a time stamp. As such, the network node 110 may use the LCID 710 to interpret the unsuccessful HARQ termination event information 720a in accordance with the event type indicated by the LCID 710 (e.g., type 1A event, type 1B event, type 2A event, or type 2B event). For instance, the network node 110 may use the LCID 710 to determine how to interpret the NDI and/or the time stamp included in unsuccessful HARQ termination event information 720a.

Additionally, or alternatively, the unsuccessful HARQ termination report may include information associated with multiple unsuccessful HARQ termination events of a same event type. For example, as illustrated in FIG. 7, the unsuccessful HARQ termination report may optionally include unsuccessful HARQ termination event information 720b, which may include information associated with a second unsuccessful HARQ termination event that is different than the unsuccessful HARQ termination event associated with unsuccessful HARQ termination event information 720a. In the case of multiple unsuccessful HARQ termination events indicated in example 700, each of the multiple unsuccessful HARQ termination events may be of a same event type. That is both unsuccessful HARQ termination event information 720a and unsuccessful HARQ termination event information 720b are associated with LCID 710 and are therefore associated with the same event type (e.g., type 1A event, type 1B event, type 2A event, or type 2B event).

Additionally, in cases of multiple unsuccessful HARQ termination events indicated in example 700, the unsuccessful HARQ termination report may include and indicate report structure information 715. In some examples, the report structure information 715 may indicate a size of the unsuccessful HARQ termination report (e.g., a size of the variable-length MAC-CE). In some examples, the report structure information 715 may indicate a quantity of unsuccessful HARQ termination events indicated in the unsuccessful HARQ termination report (e.g., via another field of the MAC-CE report). In some examples, the report structure information 715 may indicate presence or absence of a next unsuccessful HARQ termination event in the information associated with the previous unsuccessful HARQ termination event. For example, the unsuccessful HARQ termination event information 720a may include a bit field of a first value that indicates that there is subsequent information associated with another unsuccessful HARQ termination event. Additionally, or alternatively, the unsuccessful HARQ termination event information 720b may include a bit field of a second value that indicates that there is no subsequent information associated with another unsuccessful HARQ termination event.

As described herein, the example 700 may include information associated with multiple unsuccessful HARQ termination events if each of the multiple unsuccessful HARQ termination events are of the same event type. If, however, the UE 120 detects multiple unsuccessful HARQ termination events of different event types, then the UE 120 may transmit multiple reports corresponding to respective event types. For instance, if a first unsuccessful HARQ termination event is of type 1A, a second unsuccessful HARQ termination event is of type 2B, and a third unsuccessful HARQ termination event is of type 1A, then the UE 120 may transmit a first unsuccessful HARQ termination report that includes a first LCID associated with the type 1A event and further includes information associated with the first and third unsuccessful HARQ termination event. Additionally, the UE 120 may transmit a second unsuccessful HARQ termination report that includes a second LCID associated with the type 2B event and includes information associated with the second unsuccessful HARQ termination event. In some examples, different unsuccessful HARQ termination reports associated with different LCIDs may be included in a same uplink transmission (e.g., different MAC-CEs may be part of the same PUSCH transmission and/or same uplink transport block). In some examples, different unsuccessful HARQ termination reports associated with different LCIDs may be included in different uplink transmissions (e.g., different MAC-CEs may be part of the different PUSCH transmissions and/or different uplink transport blocks).

By including a the LCID 710 in the unsuccessful HARQ termination report, the UE 120 may reduce misinterpretation at the network node 110 of how to handle unsuccessful HARQ termination event information 720, which may result in faster resolution of the unsuccessful HARQ termination event, decreasing latency. Additionally, by including multiple unsuccessful HARQ termination events in the same unsuccessful HARQ termination report, the UE 120 and network node 110 may concurrently resolve multiple unsuccessful HARQ termination events of the same event type, without increasing signal overhead. Additionally, by using the LCID 710 for indication of the event type, the UE 120 may leverage existing structure of a MAC-CE report without increasing the complexity of the reporting structure. Additionally, in cases of multiple unsuccessful HARQ termination events being indicated, the LCID 710 may serve as a global event type indicator, allowing the network node 110 to determine the event type for each of the multiple unsuccessful HARQ termination events from a single field, which may reduce a possibility for misinterpretation at the network node 110, reduce the complexity and size of the unsuccessful HARQ termination report.

As indicated above, FIG. 7 is provided as an example. Other examples may differ from what is described with regard to FIG. 7.

FIG. 8 is a diagram illustrating an example 800 of an unsuccessful HARQ termination report, in accordance with the present disclosure. The example 800 may implement or be implemented by one or more of wireless communication network 100, disaggregated network node architecture 200, example 300, example 400, example 500, or example 600. For instance, example 800 depicts a structure of the unsuccessful HARQ termination report 535, as described with reference to FIG. 5. In some examples, the UE 120 may transmit to the network node 110 the report depicted in example 800 to indicate a type of unsuccessful HARQ termination event associated with one or more detected unsuccessful HARQ termination events. In the example 800, the unsuccessful HARQ termination report may be a MAC-CE report that the UE 120 transmits in a transport block via PUSCH or PUCCH. However, it is understood that the unsuccessful HARQ termination report may be of other signaling types (e.g., RRC signaling or UCI).

As illustrated in example 800, the unsuccessful HARQ termination report may include a set of fields that indicate information associated with a first unsuccessful HARQ termination event (e.g., event 805a). For example, the fields associated with event 805a may include one or more of a type 810 (e.g., type 540 with reference to FIG. 5), a HARQ process identifier 815 (e.g., HARQ identifier 510 with reference to FIG. 5), a NDI 820 (e.g., NDI 515b with reference to FIG. 5), a serving cell identifier (e.g., associated with or indicative of the CC index 545 with reference to FIG. 5), a time stamp 830 (e.g., time stamp 555 with reference to FIG. 5), a presence indicator 835 (e.g., indicating the presence of fields associated with subsequent events such as event 805b and/or event 805c), and one or more of reserved bits 840 (e.g., a quantity of bits that are reserved for future use or to ensure proper alignment of the report). Additionally, each of the fields associated with event 805a may be include a quantity of bits. For example, type 810 may include a first quantity of bits (such as two bits, to differentiate between the type 1A event, type 1B event, type 2A event, or type 2B event), the HARQ process identifier 815 may include a second quantity of bits (such as four bits, to differentiate between 16 possible HARQ identifiers), the NDI 820 may include up to a third quantity of bits (such as two bits), the serving cell identifier 825 may include a third quantity of bits (such as five bits, to differentiate between 32 possible CCs), the time stamp 830 may be a fourth quantity of bits (such as eight bits), the presence indicator 835 may be one bit (e.g., a first value indicating presence of one or more fields associated with an additional event, and a second value indicating absence of any additional events), and one or more reserved bits 840.

In accordance with example 800, the type 810 of unsuccessful HARQ termination report may be a field of the unsuccessful HARQ termination report that indicates the type of unsuccessful HARQ termination event associated with event 805a (e.g., a field in a MAC-CE report). For example, based on receiving the unsuccessful HARQ termination report depicted in example 800, the network node 110 may determine the type of unsuccessful HARQ termination event in accordance with the a value of type 810 included in the event 805a. In some examples, the type 810 may differentiate between each of the four event types (e.g., type 1A event, type 1B event, type 2A event, or type 2B event). In some examples, the type 810 may differentiate between event type 1A/1B and event type 2A/2B (e.g., distinguish between unsuccessful HARQ termination event detected based on a subsequent DCI and detected based on expiration of a timer at the UE 120). In some examples, the type 810 may differentiate between event type 1A/2A and event type 1B/2B (e.g., distinguish between unsuccessful HARQ termination event detected after transmission of a HARQ NACK indication and detected after transmission of a HARQ ACK indication).

Additionally, or alternatively, the unsuccessful HARQ termination report may include information associated with multiple unsuccessful HARQ termination events. For example, as illustrated in FIG. 8, the unsuccessful HARQ termination report may optionally include one or more fields associated with event 805b and/or one or more fields associated with event 805c. While example 800 illustrates event 805a, 805b, and 805c, it is understood that the unsuccessful HARQ termination report may indicate any quantity of unsuccessful HARQ termination events.

Additionally, in cases of multiple unsuccessful HARQ termination events indicated in example 800, the unsuccessful HARQ termination report may indicate report structure information. In some examples, the report structure information may indicate a size of the unsuccessful HARQ termination report (e.g., a size of the variable-length MAC-CE). In some examples, the report structure information may indicate a quantity of unsuccessful HARQ termination events indicated in the unsuccessful HARQ termination report (e.g., via another field of the MAC-CE report). In some examples, the report structure information may indicate presence or absence of a next unsuccessful HARQ termination event in the information associated with the previous unsuccessful HARQ termination event. For instance, in the case where event 805a, 805b, and 805c are each included in the unsuccessful HARQ termination report, the presence indicator 835 of event 805a may be of the first value indicating one or more fields of a subsequent event (e.g., indicative of the presence of event 805b), the presence indicator 835 of event 805b may be of the first value indicating one or more fields of a subsequent event (e.g., indicative of the presence of event 805c), and the presence indicator 835 of event 805c may be of the second value indicating the absence of a subsequent event (e.g., indicative that event 805c is the last event included in the unsuccessful HARQ termination report).

In some examples, the example 800 may indicate multiple unsuccessful HARQ termination events of the same or different types. In first example, each of event 805a, 805b, and 805c may be of a same event type (e.g., the value of the type 810 for each of event 805a, 805b, and 805c indicates a same event type). In a first a second example, one or more of the events 805 may be of a first event type and one or more events 805 may be of a second event type. For instance, event 805a and 805c may be associated with the event 1A type, and event 805b may be associated with the event 2B type. In a third example, each of the events 805 may be associated with different event types. For instance, event 805a may be associated with the event 1A type, event 805b may be associated with the event 2B type, and event 805c may be associated with the event 1B type. As such, each event 805 included in the unsuccessful HARQ termination report may be associated with a respective type 810 field that indicates a respective event type (e.g., multiple type 810 fields in the MAC-CE).

By including the type 810 filed in the unsuccessful HARQ termination report, the UE 120 may reduce misinterpretation at the network node 110 of how to handle one or more fields associated with an event 805, which may result in faster resolution of the unsuccessful HARQ termination event, decreasing latency. Additionally, by including multiple events 805 in the same unsuccessful HARQ termination report, the UE 120 and network node 110 may concurrently resolve multiple unsuccessful HARQ termination events of the same or different types, without increasing signal overhead. Additionally, by including multiple events 805 of different types in the same unsuccessful HARQ termination report may reduce the quantity of reports the UE 120 transmits, reducing signal overhead.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with techniques for type indications for unsuccessful HARQ process termination reporting.

As shown in FIG. 9, in some aspects, process 900 may include receiving, from a network node, a first communication associated with a HARQ process (block 910).

For example, the UE (e.g., using reception component 1202 and/or communication manager 1206, depicted in FIG. 12) may receive, from a network node, a first communication associated with a HARQ process, as described above.

As further shown in FIG. 9, in some aspects, process 900 may include detecting an unsuccessful HARQ termination event associated with the HARQ process, wherein the unsuccessful HARQ termination event is associated with a type (block 920). For example, the UE (e.g., using communication manager 1206, depicted in FIG. 12) may detect an unsuccessful HARQ termination event associated with the HARQ process, wherein the unsuccessful HARQ termination event is associated with a type, as described above.

As further shown in FIG. 9, in some aspects, process 900 may include transmitting, to the network node, a second communication indicating the unsuccessful HARQ termination event, wherein the second communication indicates the type associated with the unsuccessful HARQ termination event (block 930). For example, the UE (e.g., using transmission component 1204 and/or communication manager 1206, depicted in FIG. 12) may transmit, to the network node, a second communication indicating the unsuccessful HARQ termination event, wherein the second communication indicates the type associated with the unsuccessful HARQ termination event, as described above.

Process 900 may include additional aspects, such as any single aspect or any combination of aspects described below and/or in connection with one or more other processes described elsewhere herein.

In a first aspect, the second communication comprises one or more fields, and wherein one or more values of the one or more fields are based at least in part on the type.

In a second aspect, alone or in combination with the first aspect, the one or more fields include at least one of a time stamp field or a NDI field.

In a third aspect, alone or in combination with one or more of the first and second aspects, one or more fields included in the second communication are based at least in part on the type.

In a fourth aspect, alone or in combination with one or more of the first through third aspects, a presence or absence of one or more fields included in the second communication is based at least in part on the type.

In a fifth aspect, alone or in combination with one or more of the first through fourth aspects, the type associated with the unsuccessful HARQ termination event is one type from a set of types.

In a sixth aspect, alone or in combination with one or more of the first through fifth aspects, a value of a time stamp and a value of a NDI indicated in the second communication is based at least in part on the type from the set of types.

In a seventh aspect, alone or in combination with one or more of the first through sixth aspects, the type associated with the unsuccessful HARQ termination event is one type of a set of two types, wherein the set of two types comprises a first type indicating that the UE detected the unsuccessful HARQ termination event in accordance with reception at the UE of a third communication associated with the HARQ process, and a second type indicating expiration of a timer at the UE, wherein the timer is initiated after transmission by the UE of a feedback communication associated with the first communication.

In an eighth aspect, alone or in combination with one or more of the first through seventh aspects, a value of a time stamp indicated in the second communication is based at least in part on the type of the set of two types.

In a ninth aspect, alone or in combination with one or more of the first through eighth aspects, the type associated with the unsuccessful HARQ termination event is one type of a set of two types, wherein the set of two types comprises a first type indicating that the UE detected the unsuccessful HARQ termination event after a transmission by the UE of a negative acknowledgment indication associated with the first communication, and a second type indicating that the UE detected the unsuccessful HARQ termination event after a transmission by the UE of an acknowledgment indication associated with the first communication.

In a tenth aspect, alone or in combination with one or more of the first through ninth aspects, a value of a NDI indicated in the second communication is based at least in part on the type of the set of two types.

In an eleventh aspect, alone or in combination with one or more of the first through tenth aspects, a header of the second communication indicates a first LCID that is associated with the type.

In a twelfth aspect, alone or in combination with one or more of the first through eleventh aspects, the unsuccessful HARQ termination event is one of a plurality of unsuccessful HARQ termination events identified by the UE, and wherein the second communication indicates the plurality of unsuccessful HARQ termination events based at least in part on the plurality of unsuccessful HARQ termination events being of a same type.

In a thirteenth aspect, alone or in combination with one or more of the first through twelfth aspects, the second communication includes information associated with the plurality of unsuccessful HARQ termination events that indicates at least one of a size of the second communication, a quantity of HARQ termination events indicated in the second communication, or a presence of a next unsuccessful HARQ termination event indicated in the second communication.

In a fourteenth aspect, alone or in combination with one or more of the first through thirteenth aspects, the second communication indicates that the second communication includes the information associated with the plurality of unsuccessful HARQ termination events.

In a fifteenth aspect, alone or in combination with one or more of the first through fourteenth aspects, process 900 includes detecting a second unsuccessful HARQ termination event associated with the HARQ process, wherein the second unsuccessful HARQ termination event is associated with a different type than the type, and transmitting a third communication indicating the second unsuccessful HARQ termination event, wherein a header of the third communication indicates a second LCID that is associated with the different type.

In a sixteenth aspect, alone or in combination with one or more of the first through fifteenth aspects, a field of the second communication indicates the type.

In a seventeenth aspect, alone or in combination with one or more of the first through sixteenth aspects, the second communication includes multiple type indicator fields that each indicate a respective type associated with a respective unsuccessful HARQ termination event.

In an eighteenth aspect, alone or in combination with one or more of the first through seventeenth aspects, the multiple type indicator fields are each associated with a same type of unsuccessful HARQ termination event.

In a nineteenth aspect, alone or in combination with one or more of the first through eighteenth aspects, the multiple type indicator fields are each associated with different types of unsuccessful HARQ termination events.

In a twentieth aspect, alone or in combination with one or more of the first through nineteenth aspects, the second communication includes information associated with the multiple type indicator fields that indicates at least one of a size of the second communication, a quantity of HARQ termination events indicated in the second communication, or a presence of a next unsuccessful HARQ termination event indicated in the second communication.

In a twenty-first aspect, alone or in combination with one or more of the first through twentieth aspects, the second communication indicates that the second communication includes the information associated with the multiple type indicator fields.

In a twenty-second aspect, alone or in combination with one or more of the first through twenty-first aspects, the second communication indicates one or more of a component carrier index associated with the first communication, a HARQ process identifier associated with the first communication, a NDI based at least in part on the type, or a time stamp based at least in part on the type.

In a twenty-third aspect, alone or in combination with one or more of the first through twenty-second aspects, process 900 includes identifying a type of unsuccessful HARQ termination event based on receiving the first communication associated with the HARQ process.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with techniques for type indications for unsuccessful HARQ process termination reporting.

As shown in FIG. 10, in some aspects, process 1000 may include transmitting, to a UE, a first communication associated with a HARQ process (block 1010). For example, the network node (e.g., using transmission component 1304 and/or communication manager 1306, depicted in FIG. 13) may transmit, to a UE, a first communication associated with a HARQ process, as described above.

As further shown in FIG. 10, in some aspects, process 1000 may include receiving, from the UE, a second communication indicating an unsuccessful HARQ termination event, wherein the second communication indicates a type associated with the unsuccessful HARQ termination event (block 1020). For example, the network node (e.g., using reception component 1302 and/or communication manager 1306, depicted in FIG. 13) may receive, from the UE, a second communication indicating an unsuccessful HARQ termination event, wherein the second communication indicates a type associated with the unsuccessful HARQ termination event, as described above.

Process 1000 may include additional aspects, such as any single aspect or any combination of aspects described below and/or in connection with one or more other processes described elsewhere herein.

In a first aspect, the second communication comprises one or more fields, and wherein one or more values of the one or more fields are based at least in part on the type.

In a second aspect, alone or in combination with the first aspect, the one or more fields include at least one of a time stamp field or a NDI field.

In a third aspect, alone or in combination with one or more of the first and second aspects, one or more fields included in the second communication are based at least in part on the type.

In a fourth aspect, alone or in combination with one or more of the first through third aspects, a presence or absence of one or more fields included in the second communication is based at least in part on the type.

In a fifth aspect, alone or in combination with one or more of the first through fourth aspects, the type associated with the unsuccessful HARQ termination event is one type from a set of types.

In a sixth aspect, alone or in combination with one or more of the first through fifth aspects, a value of a time stamp and a value of a NDI indicated in the second communication is based at least in part on the type from the set of types.

In a seventh aspect, alone or in combination with one or more of the first through sixth aspects, the type associated with the unsuccessful HARQ termination event is one type of a set of two types, wherein the set of two types comprises a first type indicating that the UE detected the unsuccessful HARQ termination event in accordance with reception at the UE of a third communication associated with the HARQ process, and a second type indicating expiration of a timer at the UE, wherein the timer is initiated after transmission by the UE of a feedback communication associated with the first communication.

In an eighth aspect, alone or in combination with one or more of the first through seventh aspects, a value of a time stamp indicated in the second communication is based at least in part on the type of the set of two types.

In a ninth aspect, alone or in combination with one or more of the first through eighth aspects, the type associated with the unsuccessful HARQ termination event is one type of a set of two types, wherein the set of two types comprises a first type indicating that the UE detected the unsuccessful HARQ termination event after a transmission by the UE of a negative acknowledgment indication associated with the first communication, and a second type indicating that the UE detected the unsuccessful HARQ termination event after a transmission by the UE of an acknowledgment indication associated with the first communication.

In a tenth aspect, alone or in combination with one or more of the first through ninth aspects, a value of a NDI indicated in the second communication is based at least in part on the type of the set of two types.

In an eleventh aspect, alone or in combination with one or more of the first through tenth aspects, a header of the second communication indicates a first LCID that is associated with the type.

In a twelfth aspect, alone or in combination with one or more of the first through eleventh aspects, the unsuccessful HARQ termination event is one of a plurality of unsuccessful HARQ termination events identified by the UE, and wherein the second communication indicates the plurality of unsuccessful HARQ termination events based at least in part on the plurality of unsuccessful HARQ termination events being of a same type.

In a thirteenth aspect, alone or in combination with one or more of the first through twelfth aspects, the second communication includes information associated with the plurality of unsuccessful HARQ termination events that indicates at least one of a size of the second communication, a quantity of HARQ termination events indicated in the second communication, or a presence of a next unsuccessful HARQ termination event indicated in the second communication.

In a fourteenth aspect, alone or in combination with one or more of the first through thirteenth aspects, the second communication indicates that the second communication includes the information associated with the plurality of unsuccessful HARQ termination events.

In a fifteenth aspect, alone or in combination with one or more of the first through fourteenth aspects, process 1000 includes receiving a third communication indicating a second unsuccessful HARQ termination event associated with the HARQ process, wherein the second unsuccessful HARQ termination event is associated with a different type than the type, and wherein a header of the third communication indicates a second LCID that is associated with the different type.

In a sixteenth aspect, alone or in combination with one or more of the first through fifteenth aspects, a field of the second communication indicates the type.

In a seventeenth aspect, alone or in combination with one or more of the first through sixteenth aspects, the second communication includes multiple type indicator fields that each indicate a respective type associated with a respective unsuccessful HARQ termination event.

In an eighteenth aspect, alone or in combination with one or more of the first through seventeenth aspects, the multiple type indicator fields are each associated with a same type of unsuccessful HARQ termination event.

In a nineteenth aspect, alone or in combination with one or more of the first through eighteenth aspects, the multiple type indicator fields are each associated with different types of unsuccessful HARQ termination events.

In a twentieth aspect, alone or in combination with one or more of the first through nineteenth aspects, the second communication includes information associated with the multiple type indicator fields that indicates at least one of a size of the second communication, a quantity of HARQ termination events indicated in the second communication, or a presence of a next unsuccessful HARQ termination event indicated in the second communication.

In a twenty-first aspect, alone or in combination with one or more of the first through twentieth aspects, the second communication indicates that the second communication includes the information associated with the multiple type indicator fields.

In a twenty-second aspect, alone or in combination with one or more of the first through twenty-first aspects, the second communication indicates one or more of a component carrier index associated with the first communication, a HARQ process identifier associated with the first communication, a NDI based at least in part on the type, or a time stamp based at least in part on the type.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with techniques for type indications for unsuccessful HARQ process termination reporting.

As shown in FIG. 11, in some aspects, process 1100 may include transmitting, to a UE, a first communication associated with a HARQ process, wherein the first communication is associated with one or more SDUs stored in a buffer of the network node (block 1110). For example, the network node (e.g., using transmission component 1304 and/or communication manager 1306, depicted in FIG. 13) may transmit, to a UE, a first communication associated with a HARQ process, wherein the first communication is associated with one or more SDUs stored in a buffer of the network node, as described above.

As further shown in FIG. 11, in some aspects, process 1100 may include removing the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication (block 1120). For example, the network node (e.g., using communication manager 1306, depicted in FIG. 13) may remove the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication, as described above.

Process 1100 may include additional aspects, such as any single aspect or any combination of aspects described below and/or in connection with one or more other processes described elsewhere herein.

In a first aspect, process 1100 includes determining that the UE successfully received the first communication based at least in part on not receiving the feedback communication prior to expiration of the time period, wherein removal of the one or more SDUs stored in the buffer is based at least in part on the determination.

In a second aspect, alone or in combination with the first aspect, process 1100 includes transmitting, to the UE, configuration information indicating a value of a timer associated with reception of the first communication by the UE.

In a third aspect, alone or in combination with one or more of the first and second aspects, the configuration information indicates to the UE to initiate the timer in response to transmission of the negative acknowledgment indication or an acknowledgment indication associated with the first communication based at least in part on the first communication being associated with the HARQ process.

In a fourth aspect, alone or in combination with one or more of the first through third aspects, the time period is based at least in part on the value of the timer indicated in the configuration information, an uplink latency value associated with receiving uplink communications from the UE, or both.

In a fifth aspect, alone or in combination with one or more of the first through fourth aspects, the one or more SDUs include one or more RLC SDUs, one or more SDU segments, or both.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 1-8. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a network node, a first communication associated with a HARQ process. The communication manager 1206 may detect an unsuccessful HARQ termination event associated with the HARQ process, wherein the unsuccessful HARQ termination event is associated with a type. The transmission component 1204 may transmit, to the network node, a second communication indicating the unsuccessful HARQ termination event, wherein the second communication indicates the type associated with the unsuccessful HARQ termination event.

The communication manager 1206 may detect a second unsuccessful HARQ termination event associated with the HARQ process, wherein the second unsuccessful HARQ termination event is associated with a different type than the type.

The transmission component 1204 may transmit a third communication indicating the second unsuccessful HARQ termination event, wherein a header of the third communication indicates a second LCID that is associated with the different type.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 1-8. Additionally, or alternatively, the apparatus 1300 may be configured to perform one or more processes described herein, such as process 1000 of FIG. 10, process 1100 of FIG. 11, or a combination thereof. In some aspects, the apparatus 1300 and/or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a UE, a first communication associated with a HARQ process. The reception component 1302 may receive, from the UE, a second communication indicating an unsuccessful HARQ termination event, wherein the second communication indicates a type associated with the unsuccessful HARQ termination event.

The reception component 1302 may receive a third communication indicating a second unsuccessful HARQ termination event associated with the HARQ process, wherein the second unsuccessful HARQ termination event is associated with a different type than the type, and wherein a header of the third communication indicates a second LCID that is associated with the different type.

The transmission component 1304 may transmit, to a UE, a first communication associated with a HARQ process, wherein the first communication is associated with one or more SDUs stored in a buffer of the network node. The communication manager 1306 may remove the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.

The communication manager 1306 may determine that the UE successfully received the first communication based at least in part on not receiving the feedback communication prior to expiration of the time period, wherein removal of the one or more SDUs stored in the buffer is based at least in part on the determination.

The transmission component 1304 may transmit, to the UE, configuration information indicating a value of a timer associated with reception of the first communication by the UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving, from a network node, a first communication associated with a hybrid automatic repeat request (HARQ) process; detecting an unsuccessful HARQ termination event associated with the HARQ process, wherein the unsuccessful HARQ termination event is associated with a type; and transmitting, to the network node, a second communication indicating the unsuccessful HARQ termination event, wherein the second communication indicates the type associated with the unsuccessful HARQ termination event.
Aspect 2: The method of Aspect 1, wherein the second communication comprises one or more fields, and wherein one or more values of the one or more fields are based at least in part on the type.
Aspect 3: The method of Aspect 2, wherein the one or more fields include at least one of a time stamp field or a new data indicator (NDI) field.
Aspect 4: The method of any of Aspects 1-3, wherein one or more fields included in the second communication are based at least in part on the type.
Aspect 5: The method of any of Aspects 1-4, wherein a presence or absence of one or more fields included in the second communication is based at least in part on the type.
Aspect 6: The method of any of Aspects 1-5, wherein the type associated with the unsuccessful HARQ termination event is one type from a set of types.
Aspect 7: The method of Aspect 6, wherein a value of a time stamp and a value of a new data indicator (NDI) indicated in the second communication is based at least in part on the type from the set of types.
Aspect 8: The method of any of Aspects 1-7, wherein the type associated with the unsuccessful HARQ termination event is one type of a set of two types, wherein the set of two types comprises: a first type indicating that the UE detected the unsuccessful HARQ termination event in accordance with reception at the UE of a third communication associated with the HARQ process, and a second type indicating expiration of a timer at the UE, wherein the timer is initiated after transmission by the UE of a feedback communication associated with the first communication.
Aspect 9: The method of Aspect 8, wherein a value of a time stamp indicated in the second communication is based at least in part on the type of the set of two types.
Aspect 10: The method of any of Aspects 1-9, wherein the type associated with the unsuccessful HARQ termination event is one type of a set of two types, wherein the set of two types comprises: a first type indicating that the UE detected the unsuccessful HARQ termination event after a transmission by the UE of a negative acknowledgment indication associated with the first communication, and a second type indicating that the UE detected the unsuccessful HARQ termination event after a transmission by the UE of an acknowledgment indication associated with the first communication.
Aspect 11: The method of Aspect 10, wherein a value of a new data indicator (NDI) indicated in the second communication is based at least in part on the type of the set of two types.
Aspect 12: The method of any of Aspects 1-11, wherein a header of the second communication indicates a first logical channel identifier (LCID) that is associated with the type.
Aspect 13: The method of Aspect 12, wherein the unsuccessful HARQ termination event is one of a plurality of unsuccessful HARQ termination events identified by the UE, and wherein the second communication indicates the plurality of unsuccessful HARQ termination events based at least in part on the plurality of unsuccessful HARQ termination events being of a same type.
Aspect 14: The method of Aspect 13, wherein the second communication includes information associated with the plurality of unsuccessful HARQ termination events that indicates at least one of a size of the second communication, a quantity of HARQ termination events indicated in the second communication, or a presence of a next unsuccessful HARQ termination event indicated in the second communication.
Aspect 15: The method of Aspect 14, wherein the second communication indicates that the second communication includes the information associated with the plurality of unsuccessful HARQ termination events.
Aspect 16: The method of Aspect 12, further comprising: detecting a second unsuccessful HARQ termination event associated with the HARQ process, wherein the second unsuccessful HARQ termination event is associated with a different type than the type; and transmitting a third communication indicating the second unsuccessful HARQ termination event, wherein a header of the third communication indicates a second LCID that is associated with the different type.
Aspect 17: The method of any of Aspects 1-16, wherein a field of the second communication indicates the type.
Aspect 18: The method of any of Aspects 1-17, wherein the second communication includes multiple type indicator fields that each indicate a respective type associated with a respective unsuccessful HARQ termination event.
Aspect 19: The method of Aspect 18, wherein the multiple type indicator fields are each associated with a same type of unsuccessful HARQ termination event.
Aspect 20: The method of Aspect 18, wherein the multiple type indicator fields are each associated with different types of unsuccessful HARQ termination events.
Aspect 21: The method of Aspect 18, wherein the second communication includes information associated with the multiple type indicator fields that indicates at least one of a size of the second communication, a quantity of HARQ termination events indicated in the second communication, or a presence of a next unsuccessful HARQ termination event indicated in the second communication.
Aspect 22: The method of Aspect 21, wherein the second communication indicates that the second communication includes the information associated with the multiple type indicator fields.
Aspect 23: The method of any of Aspects 1-22, wherein the second communication indicates one or more of: a component carrier index associated with the first communication, a HARQ process identifier associated with the first communication, a new data indicator (NDI) based at least in part on the type, or a time stamp based at least in part on the type.
Aspect 24: A method of wireless communication performed by a network node, comprising: transmitting, to a user equipment (UE), a first communication associated with a hybrid automatic repeat request (HARQ) process; and receiving, from the UE, a second communication indicating an unsuccessful HARQ termination event, wherein the second communication indicates a type associated with the unsuccessful HARQ termination event.
Aspect 25: The method of Aspect 24, wherein the second communication comprises one or more fields, and wherein one or more values of the one or more fields are based at least in part on the type.
Aspect 26: The method of Aspect 25, wherein the one or more fields include at least one of a time stamp field or a new data indicator (NDI) field.
Aspect 27: The method of any of Aspects 24-26, wherein one or more fields included in the second communication are based at least in part on the type.
Aspect 28: The method of any of Aspects 24-27, wherein a presence or absence of one or more fields included in the second communication is based at least in part on the type.
Aspect 29: The method of any of Aspects 24-28, wherein the type associated with the unsuccessful HARQ termination event is one type from a set of types.
Aspect 30: The method of Aspect 29, wherein a value of a time stamp and a value of a new data indicator (NDI) indicated in the second communication is based at least in part on the type from the set of types.
Aspect 31: The method of any of Aspects 24-30, wherein the type associated with the unsuccessful HARQ termination event is one type of a set of two types, wherein the set of two types comprises: a first type indicating that the UE detected the unsuccessful HARQ termination event in accordance with reception at the UE of a third communication associated with the HARQ process, and a second type indicating expiration of a timer at the UE, wherein the timer is initiated after transmission by the UE of a feedback communication associated with the first communication.
Aspect 32: The method of Aspect 31, wherein a value of a time stamp indicated in the second communication is based at least in part on the type of the set of two types.
Aspect 33: The method of any of Aspects 24-32, wherein the type associated with the unsuccessful HARQ termination event is one type of a set of two types, wherein the set of two types comprises: a first type indicating that the UE detected the unsuccessful HARQ termination event after a transmission by the UE of a negative acknowledgment indication associated with the first communication, and a second type indicating that the UE detected the unsuccessful HARQ termination event after a transmission by the UE of an acknowledgment indication associated with the first communication.
Aspect 34: The method of Aspect 33, wherein a value of a new data indicator (NDI) indicated in the second communication is based at least in part on the type of the set of two types.
Aspect 35: The method of any of Aspects 24-34, wherein a header of the second communication indicates a first logical channel identifier (LCID) that is associated with the type.
Aspect 36: The method of Aspect 35, wherein the unsuccessful HARQ termination event is one of a plurality of unsuccessful HARQ termination events identified by the UE, and wherein the second communication indicates the plurality of unsuccessful HARQ termination events based at least in part on the plurality of unsuccessful HARQ termination events being of a same type.
Aspect 37: The method of Aspect 36, wherein the second communication includes information associated with the plurality of unsuccessful HARQ termination events that indicates at least one of a size of the second communication, a quantity of HARQ termination events indicated in the second communication, or a presence of a next unsuccessful HARQ termination event indicated in the second communication.
Aspect 38: The method of Aspect 37, wherein the second communication indicates that the second communication includes the information associated with the plurality of unsuccessful HARQ termination events.
Aspect 39: The method of Aspect 35, further comprising: receiving a third communication indicating a second unsuccessful HARQ termination event associated with the HARQ process, wherein the second unsuccessful HARQ termination event is associated with a different type than the type, and wherein a header of the third communication indicates a second LCID that is associated with the different type.
Aspect 40: The method of any of Aspects 24-39, wherein a field of the second communication indicates the type.
Aspect 41: The method of any of Aspects 24-40, wherein the second communication includes multiple type indicator fields that each indicate a respective type associated with a respective unsuccessful HARQ termination event.
Aspect 42: The method of Aspect 41, wherein the multiple type indicator fields are each associated with a same type of unsuccessful HARQ termination event.
Aspect 43: The method of Aspect 41, wherein the multiple type indicator fields are each associated with different types of unsuccessful HARQ termination events.
Aspect 44: The method of Aspect 41, wherein the second communication includes information associated with the multiple type indicator fields that indicates at least one of a size of the second communication, a quantity of HARQ termination events indicated in the second communication, or a presence of a next unsuccessful HARQ termination event indicated in the second communication.
Aspect 45: The method of Aspect 44, wherein the second communication indicates that the second communication includes the information associated with the multiple type indicator fields.
Aspect 46: The method of any of Aspects 24-45, wherein the second communication indicates one or more of: a component carrier index associated with the first communication, a HARQ process identifier associated with the first communication, a new data indicator (NDI) based at least in part on the type, or a time stamp based at least in part on the type.
Aspect 47: A method of wireless communication performed by a network node, comprising: transmitting, to a user equipment (UE), a first communication associated with a hybrid automatic repeat request (HARQ) process, wherein the first communication is associated with one or more service data units (SDUs) stored in a buffer of the network node; and removing the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.
Aspect 48: The method of Aspect 47, further comprising: determining that the UE successfully received the first communication based at least in part on not receiving the feedback communication prior to expiration of the time period, wherein removal of the one or more SDUs stored in the buffer is based at least in part on the determination.
Aspect 49: The method of any of Aspects 47-48, further comprising: transmitting, to the UE, configuration information indicating a value of a timer associated with reception of the first communication by the UE.
Aspect 50: The method of Aspect 49, wherein the configuration information indicates to the UE to initiate the timer in response to transmission of the negative acknowledgment indication or an acknowledgment indication associated with the first communication based at least in part on the first communication being associated with the HARQ process.
Aspect 51: The method of Aspect 49, wherein the time period is based at least in part on the value of the timer indicated in the configuration information, an uplink latency value associated with receiving uplink communications from the UE, or both.
Aspect 52: The method of any of Aspects 47-51, wherein the one or more SDUs include one or more radio link control (RLC) SDUs, one or more SDU segments, or both.
Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.
Aspect 54: An apparatus for wireless communication at a device, the apparatus comprising one or more memories and one or more processors coupled to the one or more memories, the one or more processors configured to cause the device to perform the method of one or more of Aspects 1-52.
Aspect 55: An apparatus for wireless communication, the apparatus comprising at least one means for performing the method of one or more of Aspects 1-52.
Aspect 56: A non-transitory computer-readable medium storing code for wireless communication, the code comprising instructions executable by one or more processors to perform the method of one or more of Aspects 1-52.
Aspect 57: A non-transitory computer-readable medium storing a set of instructions for wireless communication, the set of instructions comprising one or more instructions that, when executed by one or more processors of a device, cause the device to perform the method of one or more of Aspects 1-52.
Aspect 58: A device for wireless communication, the device comprising a processing system that includes one or more processors and one or more memories coupled with the one or more processors, the processing system configured to cause the device to perform the method of one or more of Aspects 1-52.
Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a network node, a first communication associated with a hybrid automatic repeat request (HARQ) process;
detect an unsuccessful HARQ termination event associated with the HARQ process, wherein the unsuccessful HARQ termination event is associated with a type; and
transmit, to the network node, a second communication indicating the unsuccessful HARQ termination event, wherein the second communication indicates the type associated with the unsuccessful HARQ termination event.

2. The UE of claim 1, wherein the second communication comprises one or more fields, and wherein one or more values of the one or more fields are based at least in part on the type.

3. The UE of claim 2, wherein the one or more fields include at least one of a time stamp field or a new data indicator (NDI) field.

4. The UE of claim 1, wherein one or more fields included in the second communication are based at least in part on the type.

5. The UE of claim 1, wherein a presence or absence of one or more fields included in the second communication is based at least in part on the type.

6. The UE of claim 1, wherein the type associated with the unsuccessful HARQ termination event is one type from a set of types.

7. The UE of claim 6, wherein a value of a time stamp and a value of a new data indicator (NDI) indicated in the second communication is based at least in part on the type from the set of types.

8. The UE of claim 1, wherein the type associated with the unsuccessful HARQ termination event is one type of a set of two types, wherein the set of two types comprises:
a first type indicating that the UE detected the unsuccessful HARQ termination event in accordance with reception at the UE of a third communication associated with the HARQ process, and
a second type indicating expiration of a timer at the UE, wherein the timer is initiated after transmission by the UE of a feedback communication associated with the first communication.

9. The UE of claim 8, wherein a value of a time stamp indicated in the second communication is based at least in part on the type of the set of two types.

10. The UE of claim 1, wherein the type associated with the unsuccessful HARQ termination event is one type of a set of two types, wherein the set of two types comprises:
a first type indicating that the UE detected the unsuccessful HARQ termination event after a transmission by the UE of a negative acknowledgment indication associated with the first communication, and
a second type indicating that the UE detected the unsuccessful HARQ termination event after a transmission by the UE of an acknowledgment indication associated with the first communication.

11. The UE of claim 10, wherein a value of a new data indicator (NDI) indicated in the second communication is based at least in part on the type of the set of two types.

12. The UE of claim 1, wherein a header of the second communication indicates a first logical channel identifier (LCID) that is associated with the type.

13. The UE of claim 12, wherein the unsuccessful HARQ termination event is one of a plurality of unsuccessful HARQ termination events identified by the UE, and wherein the second communication indicates the plurality of unsuccessful HARQ termination events based at least in part on the plurality of unsuccessful HARQ termination events being of a same type.

14. The UE of claim 13, wherein the second communication includes information associated with the plurality of unsuccessful HARQ termination events that indicates at least one of a size of the second communication, a quantity of HARQ termination events indicated in the second communication, or a presence of a next unsuccessful HARQ termination event indicated in the second communication.

15. The UE of claim 14, wherein the second communication indicates that the second communication includes the information associated with the plurality of unsuccessful HARQ termination events.

16. The UE of claim 12, wherein the one or more processors are further configured to cause the UE to:
detect a second unsuccessful HARQ termination event associated with the HARQ process, wherein the second unsuccessful HARQ termination event is associated with a different type than the type; and
transmit a third communication indicating the second unsuccessful HARQ termination event, wherein a header of the third communication indicates a second LCID that is associated with the different type.

17. The UE of claim 1, wherein a field of the second communication indicates the type.

18. The UE of claim 1, wherein the second communication includes multiple type indicator fields that each indicate a respective type associated with a respective unsuccessful HARQ termination event.

19. The UE of claim 18, wherein the multiple type indicator fields are each associated with a same type of unsuccessful HARQ termination event.

20. The UE of claim 18, wherein the multiple type indicator fields are each associated with different types of unsuccessful HARQ termination events.

21. The UE of claim 18, wherein the second communication includes information associated with the multiple type indicator fields that indicates at least one of a size of the second communication, a quantity of HARQ termination events indicated in the second communication, or a presence of a next unsuccessful HARQ termination event indicated in the second communication.

22. The UE of claim 21, wherein the second communication indicates that the second communication includes the information associated with the multiple type indicator fields.

23. The UE of claim 1, wherein the second communication indicates one or more of:
a component carrier index associated with the first communication,
a HARQ process identifier associated with the first communication,
a new data indicator (NDI) based at least in part on the type, or
a time stamp based at least in part on the type.

24. A network node for wireless communication, comprising:
one or more memories; and
one or more processors, coupled to the one or more memories, configured to cause the network node to:
transmit, to a user equipment (UE), a first communication associated with a hybrid automatic repeat request (HARQ) process; and
receive, from the UE, a second communication indicating an unsuccessful HARQ termination event, wherein the second communication indicates a type associated with the unsuccessful HARQ termination event.

25. A network node for wireless communication, comprising:
one or more memories; and
one or more processors, coupled to the one or more memories, configured to cause the network node to:
transmit, to a user equipment (UE), a first communication associated with a hybrid automatic repeat request (HARQ) process, wherein the first communication is associated with one or more service data units (SDUs) stored in a buffer of the network node; and
remove the one or more SDUs stored in the buffer based at least in part on expiration of a time period following transmission of the first communication without the network node receiving, from the UE, a feedback communication that indicates an unsuccessful HARQ termination event associated with the first communication or a negative acknowledgment indication associated with the first communication.

26. The network node of claim 25, wherein the one or more processors are further configured to cause the network node to:
determine that the UE successfully received the first communication based at least in part on not receiving the feedback communication prior to expiration of the time period, wherein removal of the one or more SDUs stored in the buffer is based at least in part on the determination.

27. The network node of claim 25, wherein the one or more processors are further configured to cause the network node to:
transmit, to the UE, configuration information indicating a value of a timer associated with reception of the first communication by the UE.

28. The network node of claim 27, wherein the configuration information indicates to the UE to initiate the timer in response to transmission of the negative acknowledgment indication or an acknowledgment indication associated with the first communication based at least in part on the first communication being associated with the HARQ process.

29. The network node of claim 27, wherein the time period is based at least in part on the value of the timer indicated in the configuration information, an uplink latency value associated with receiving uplink communications from the UE, or both.

30. A method of wireless communication performed by a user equipment (UE), comprising:
receiving, from a network node, a first communication associated with a hybrid automatic repeat request (HARQ) process;
detecting an unsuccessful HARQ termination event associated with the HARQ process, wherein the unsuccessful HARQ termination event is associated with a type; and
transmitting, to the network node, a second communication indicating the unsuccessful HARQ termination event, wherein the second communication indicates the type associated with the unsuccessful HARQ termination event.
